(19) United States
(12) Patent Application Publication
(10) Pub. No.: US 2019/0384762 A1
(43) Pub. Date: Dec. 19, 2019

(54) COMPUTER-IMPLEMENTED METHOD OF QUERYING A DATASET

(71) Applicant: COUNT TECHNOLOGIES LTD., London (GB)

(72) Inventors: Edward HILL, London (GB); Oliver PIKE, London (GB); Oliver HUGHES, London (GB)

(21) Appl. No.: 16/485,023

(22) PCT Filed: Feb. 12, 2018
(86) PCT No.: PCT/GB2018/050380

§ 371 Date: Aug. 9, 2019

(30) Foreign Application Priority Data
Feb. 10, 2017 (GB) 1702216.1
Feb. 10, 2017 (GB) 1702217.9
Sep. 19, 2017 (GB) 1715083.0
Sep. 19, 2017 (GB) 1715087.1

(51) Int. Cl. G06F 16/2458; G06F 16/242; G06F 16/2457; G06F 16/248; G06N 7/00; G06F 16/22

(52) U.S. Cl. CPC G06F 16/2458; G06F 16/2425; G06F 16/2272; G06F 16/248; G06N 7/005; G06F 16/24578

(57) ABSTRACT

A computer-implemented method of querying a source dataset in which a user provides a query to a dataset querying system. The system automatically processes both the dataset and the query, so that processing the query influences the processing of the dataset, and/or processing the dataset influences the processing of the query. The system automatically processes the query and the dataset to derive a probabilistic inference of the intent behind the query. The user interacts with the relevance-ranked attempts to answer that query and the system then iteratively improves or varies how it initially processed the query and the dataset, to dynamically generate and display further relevance-ranked attempts to answer that query, to enable the user to iteratively explore the dataset or reach a useful answer.

### BACKGROUND OF THE INVENTION

### 1. Field of the Invention

The field of the invention relates to computer implemented methods and systems of analysing, querying and interacting with data.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

The ability to search, rapidly explore and gain meaningful insights across every dataset has the potential to transform the way ordinary and professional users interact with data. However, data is inherently imprecise and people's questions tend to be ambiguous. This is particularly the case when dealing with datasets from many different sources or when queries are complex.

Conventional database query systems require precision in their datasets and also precision in the queries being processed in order to produce exact outputs. Hence they cannot cope with the imperfection of the real world, such as imperfect data and ambiguity of a query.

Currently the conversion from structured data to a precise output still needs human oversight, where a series of entirely deterministic assumptions (often effected using multiple products or packages—e.g., data cleaning and querying) are performed and tracked manually making these assumptions and the associated decisions difficult to track, reverse or communicate.

Solutions to date require skilled data analysts and can be slow if data cleansing is needed first. Skilled data analysts are in many cases required to: clean data in order to reduce it to a precise form, translate ambiguous questions into a structured query language (SQL or equivalent), or manage the flow of information within the system, providing the context for how the data and query should be prepared with respect to each other. (i.e., every question potentially requires a re-examination of the data to ensure the two are consistent). In addition, the cleaning of the dataset and the translation of the query are performed by different entities (different people for example, but which may look superficially the same e.g. the same person using different disconnected programs with little ability to pass information about the assumptions made between them, or with a substantial time between performing the actions during which information is forgotten, or people using programs on the same machine, which even running on the same processor are by default unable to communicate). and no entity can be held accountable or have its actions verified by any other due to loss of information.

The solutions are therefore limited to small silos of specialists, are costly, time consuming and cannot scale: putting every dataset into context with every other scales as N², where N is the number of datasets. It is certainly not possible for a single human user to hold the context for N>100 datasets simultaneously, and difficult for N>10. Therefore a different approach is needed.

Attempts to solve this problem through standardisation are also not scalable. Standardization has been shown to be ineffective even in fields that are well suited to it (e.g., even after 30 years of standardisation, the cleaning of dates and times in data is still a time-consuming process; and, while longitude and latitude are successfully used to denote a point on the earth, there is no universal adoption of a single geographical projection) and typically involves the loss of information. In addition, current solutions are ill suited to various fields that include complex and evolving concepts, or the interaction of multiple proprietary systems, where aiding communication outside of the system is often intentionally or unintentionally neglected e.g., the Internet of Things (IoT), the digital music industry or academic research.

There is a need for a system that would enable anyone to ask complex question and that would deal with unclean data automatically, while at the same time providing the most responsive and intuitive user experience.

Delivering on this has required a paradigm shift in the way we think of querying datasets and designing databases.

### SUMMARY OF THE INVENTION

A first aspect of the invention is a computer-implemented method of querying a source dataset, in which:

(i) a user provides a query to a dataset querying system; and
(ii) the system automatically processes simultaneously and/or in a linked manner both the dataset and the query, so that processing the query influences the processing of the dataset, and/or processing the dataset influences the processing of the query.

A second aspect is a computer-implemented method of querying a source dataset, in which:

(i) a user provides a query to a dataset querying system; and
(ii) the system automatically processes the query and the dataset to derive a probabilistic inference of the intent behind the query.

A third aspect is a computer-implemented method of querying a source dataset, in which:

(i) a user provides a query to a dataset querying system; and
(ii) the system automatically processes the query and the dataset and dynamically generates a series of relevance-ranked attempts to answer that query or to infer the intent behind the query as an initial processing step; and
(iii) the user further expresses their intent by interacting with the relevance-ranked attempts to answer that query (e.g. enters a modified query, selects a part of a graph) and the system then iteratively improves or varies how it initially processed the query and the dataset, as opposed to processing in a manner unrelated to the initial processing step, to dynamically generate and display further relevance-ranked attempts to answer that query, to enable the user to iteratively explore the dataset or reach a useful answer.

Further aspects of the invention include computer-implemented systems for querying a source dataset that implement the above method-related aspects of the invention.

### BRIEF DESCRIPTION OF THE FIGURES

Aspects of the invention will now be described, by way of example(s), with reference to the following Figures, which each show features of an implementation of the invention:

FIG. 1 shows a diagram of a system including a first interpreter of the dataset, and a second interpreter of the query (prior art).

FIG. 2 shows another diagram of a system including a first interpreter of the dataset, and a second interpreter of the query, in which the first interpreter provides a dataset context alongside a structured dataset without knowledge of the query (prior art).

FIG. 3 shows another diagram of a system including two interpreters in which the second interpreter does not have knowledge of the content of the local context saved by the first interpreter (prior art).

FIG. 4 shows a diagram of a system of an implementation of the present invention, in which a computer implemented interpreter is used.

FIG. 5 shows a simplified diagram of a basic network with complex neurons.

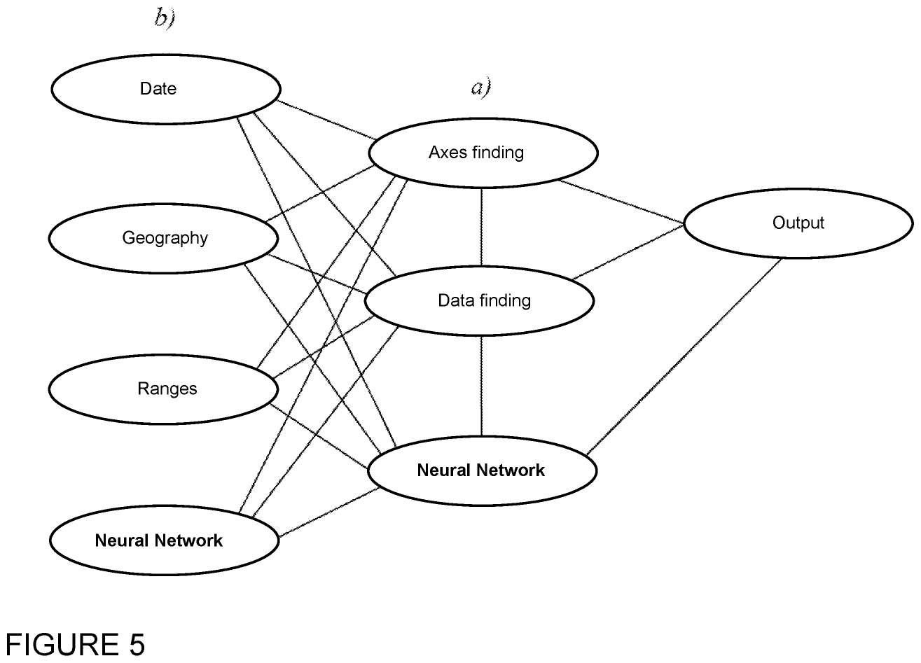

FIG. 6 shows a flow chart illustrating a number of steps performed by the database query system.

FIG. 7 shows a flow chart illustrating a number of steps performed by the database query system.

FIG. 8 shows a flow chart illustrating the user interaction steps performed by the system.

FIG. 9 shows an example of the import page including three panes.

FIG. 10 shows another example of an import page.

FIG. 11 shows another example of an import page.

FIG. 12 shows an example of the column view of an edit page.

FIG. 13 shows another example of an edit page.

FIG. 14 shows another example of an edit page.

FIG. 15 shows an example with the basic components of the explore page.

FIG. 16 shows an example with the explore page.

FIG. 17 shows an example with several autocomplete suggestions returned based on the root of their query.

FIG. 18 shows an example of a page displaying a number of answers automatically to an end-user.

FIG. 19 shows another example of a page displaying a number of answers automatically to an end-user.

FIG. 20 shows another example of a page displaying a number of answers automatically to an end-user.

FIG. 21 shows a page displaying the method used by the interpreter to process a query and a dataset.

FIG. 22 shows a screenshot of a home page.

FIG. 23 shows a screenshot of a null query screen.

FIG. 24 shows a screenshot with an obviously imprecise/incomplete query returning a selection of exact results and suggestions.

FIG. 25 shows a screenshot with a precise query returning the obviously exact answer.

FIG. 26 shows a screenshot with a graph opened with suggestions displayed in a side column.

### DETAILED DESCRIPTION

An implementation of the invention relates to a system allowing anyone to write complex queries across a large number of curated or uncurated datasets. These inherently ambiguous or imperfect queries are processed and fed into a database that is structured to handle imprecise queries and imprecise datasets. Hence, the system natively handles ambiguity and surfaces something plausible or helpful and enables ordinary and professionals users to iterate rapidly and intuitively to as precise an answer as the dataset is capable of supporting.

Instead of attempting to obtain perfectly structured data and perfectly structured queries, we instead re-architect the entire querying and database stack to work with ambiguity—the complete opposite to conventional approaches which require precision in the query and are intolerant to imperfections in the datasets.

This will transform the way people interact with data: immersive searching and exploration of datasets will become as ubiquitous and pervasive as searching the web.

### 1. Overview

The product focussed on in this work is a desktop software application (app), an example of the use of which is given. However, the technology used in the application is not limited to this use-case, and could also be used, for example, for providing data online, for hosted and cloud-based server solutions in companies, and within mobile applications. Therefore, although in the description below, the database and the front end of the product are often described in the context of the desktop application, the technology should also be considered in its other uses.

### 1.1 Definitions

### Dataset and Queries

We use the term dataset to cover any input of data to the system—for example: a csv file, an API connection, any collection of data that can be written in a relational/tabular form (e.g., tables in a SQL database, delimited text files, tables within spreadsheets), as well as any collection of data that can be written in a non-relational form (e.g., collections in a NoSQL database, nested or hierarchical files, prose, a newspaper article, pictures, sounds). Because we expansively define a dataset to include any input of data to the dataset querying system, it includes also any representation of a source dataset, including an index of that source dataset. The number and scale of the datasets that can be queried is technically unbounded (except by computational constraints)—in principle it can be extended to all datasets—such as all datasets existing in the world, including some or all web pages indexed by the Google search engine, some or all information on social networks, some or all personal information and the data generated by some or all IoT devices.

By a query we mean any input information by an end-user—for example: any type of query, precise or imprecise, a null query, a query in NL “natural language”, a gesture, a voice command, a keyword, a hint from another computer, any type of user behaviour or interaction such as a click, a visual exploration, a selection of settings, a touch or smell. It includes any interaction or user input to make the system (including the database that forms part of the system) do something and/or make the interpreter (see definition below) update its state (which typically happens as more information is provided to the interpreter).

A structured dataset is a dataset which has been created in or modified into a form which, the entity modifying it thinks is accurate and unambiguous, and which can be queried by a database.

A structured query is a query which has been created in or modified into a form which, the entity modifying it thinks is accurate and unambiguous, and which can be used by a database to act on a structured dataset.

Structured databases act by applying structured queries to structured datasets. These are the databases often found within organisations. Usually, a human intermediary converts a dataset to a structured dataset by cleaning and converts a query to a structured query by translating the query.

Structured datasets are a subset of datasets. An existing SQL database usually requires little or no cleaning for simple, self-contained analysis and is often considered to be a structured dataset, even though the conversion into a computer-usable form often introduces inaccuracy and ambiguity through the loss of information it entails. In a similar way structured queries, for example a SQL query, are a subset of queries. We could therefore describe datasets/queries which are not structured datasets/queries as unclean, imprecise or ambiguous.

### Organisation

An organisation is an entity which, as a whole, interacts with datasets and/or queries. The organisation may be made up of many more localised entities, for example employees within a company, individuals or machines (e.g. IoT devices). Organisation is used here to reflect the main contemporary use case in companies due to the nascence of individuals' interaction with data and of computers' autonomous interaction with data.

### Context

We define a dataset context to be the information which interacts with a dataset—is applied to it, or which is extracted from it—when cleaning. This could be expressed as a series of instructions or as an explanation of what has been performed. The context includes not only this information, but how to present that information to another entity, this can range from the encoding/character set/language to a relative visual layout.

We define the equivalent for a query context in the case of translation.

A dataset or query context is created as an organisation cleans a dataset or interprets a query. While some software exists to store the recipes used, this is not typical, and relates to the single source of truth problem. Broadly we can see a dataset as a structured dataset plus the dataset context, and a query as a structured query plus the query context.

A context may contain the following, but is not limited to:
Other datasets
The person's knowledge
The order and type of interactions performed or not performed
The reasons for performing or not performing those interactions, bringing in other datasets for comparison etc.

We can see a context as being itself a dataset or containing datasets. This forms a second order problem in that if the dataset contexts created from a number of datasets are themselves not structured datasets a further cleaning into a new structured dataset and context will need to be performed, and so on, recursively.

Problematically, this is typically the situation in companies—the dataset context is stored by the employee who has performed the cleaning, as a new dataset which itself has a context, and so on, but where the eventual context resides in a place inaccessible to the rest of the organisation—thoughts or private notes.

### Interpreter

We will describe both cleaning a dataset or translating a query as interpreting which is performed by an interpreter. Conventionally, these are a specially trained individual such as a data scientist, but we use it to refer to any entity. In our implementation, the interpreter is computer implemented. When an interpreter simultaneously operates on a dataset and a query it creates a context.

The Interpreter is an evolving component of the system, and the evolution of the interpreter leads to the evolution of answers. The level of information used to evolve the interpreter after an interaction is determined by the provenance and restrictions on the use of the data.

The properties, and therefore behaviour, of the interpreter may be determined by, but not limited to:
Interaction within a session,
Interaction over all sessions with a user,
Interaction over all sessions within an organisation,
Interaction within all sessions globally using public or private data.

Running a structured database with a structured query acting on a structured dataset, presenting it and adding to this the context produces the answer.

### Intent

The intent of the user is what they are trying to achieve in the system of queries and datasets we are considering. This is not necessarily explicitly discernible or inferable from their Queries and/or their Datasets in isolation, but is their goal.

### Processing or Cleaning a Dataset

Processing or cleaning a dataset has a broad meaning and may refer to any transformation that can be applied to a dataset or a portion of the dataset, such as but not limited to: finding and replacing values, deleting a column or a value, performing a function to produce a new column, transliteration of values, unit of measurement conversion, phonetic correction, format localisation, changing the type of a column or value, formatting a column or value or performing any function in relation to one or more columns. In essence, ‘cleaning’ or ‘cleansing’ the dataset means transforming the dataset such that the user's or a computer's understanding or comprehension of the dataset can be improved. As an example, the value of a column may be translated or formatted depending on the location of the user—e.g. if the user self-describes as being in New York, then the dataset could be ‘processed’ or ‘cleaned’ by joining additional map datasets that cover New York in to the dataset currently in use. Or currency amounts could be converted to USD. If the user self-describes as being a CEO, then the properties of the dataset could be altered to those which are more likely to appeal to a CEO; likewise, if the user self-describes as a data analyst, then properties of the dataset could be altered to those which are more likely to appeal to a data analyst. The scope of this term is hence significantly broader than ‘cleaning’ in the narrow sense, namely identifying incomplete, incorrect, inaccurate or irrelevant parts of the data and then replacing, modifying, or deleting the dirty or coarse data.

### Processing or Translating a Query

We will refer also to processing or translating a query. This term should be expansively interpreted to cover any process that contributes to generating a structured query. Less obvious examples within this expansive scope include, where the query is a speech input, then translation includes the speech recognition and language processing. It includes literal language A to language B translation. It includes error correction. It includes interpretation of domain specific terms in the context required, e.g. “best” of a ranking is minimum, not maximum; “seasonally adjusted” in the US is usually defined differently to in the UK/Europe.

Since the query may also be anything which makes the interpreter update its state, we also extend it in general to mean any interaction of the user which causes the interpreter to update its state. While most of the interactions of the user with the interpreter will be some form of query in the usual sense of the word.—i.e. a question, and expression of intent to receive an answer, and hence the word “Query” is used here to aid reading, we emphasise that other interactions with the interpreter may be considered in the same way. A user being in the US (and therefore likely using USD and MMDDYYYY dates) could be inferred from the questions they ask and the datasets they use, but could also be known or inferred from another interaction; for example an explicit selection by the user of their locale as US when the software was installed, or the IP address of the user being noted as being in the US when the user accesses the system over the Internet.

We will use both the capitalised and non-capitalised forms to refer to these defined terms.

### 1.2 Proposed Approach

The examples and figures below illustrate the current practice and distinguish it from the proposed approach.

The examples illustrate the role of the interpreter and of intent sitting above datasets and queries. Currently, the interpreter of the dataset, who creates the structured dataset and the dataset context, is not the interpreter of the query, nor are they aware of what the query will be.

The following pair of examples in the house price data is given, where the data consists of the columns “price”, “date”, “locality”, “district”, “county” and an example row is: “100000”, “10-02-2014T00:00”, “Retford”, “Bassetlaw”, “Nottinghamshire”
1) A first example where the village of ‘Murton’(locality), County Durham has been erroneously cleaned by giving it the other attributes (e.g. district, county etc.) of the London borough of ‘Merton’(locality). However, no dataset context is given—this cleaning is not flagged up at all (e.g. explicitly recorded)—and it is only through investigating the problem that an end-user or analyst may realise it has occurred.
2) Another example is in the ‘date’ column of the same dataset—the dates are written as e.g. “10-02-2014T00:00” which raises the question—is this because houses are technically sold/bought at midnight on the day, or is this overzealous cleaning of 10 Feb. 2014 to an ISO date format?

In both cases no answer is explicitly obvious. The first may be attributed to laziness, the second may likely be a need to get the dataset into a recognised format for a structured database.

A common pitfall demonstrated by “official” datasets such as the house price data is to assume that a structured dataset is accurate, as this is the point of the process of forming structured datasets in organisations. From discussion of the workflow with representatives from a variety of organisations, this is seen to rarely be the case.

Firstly we will explain the status quo:

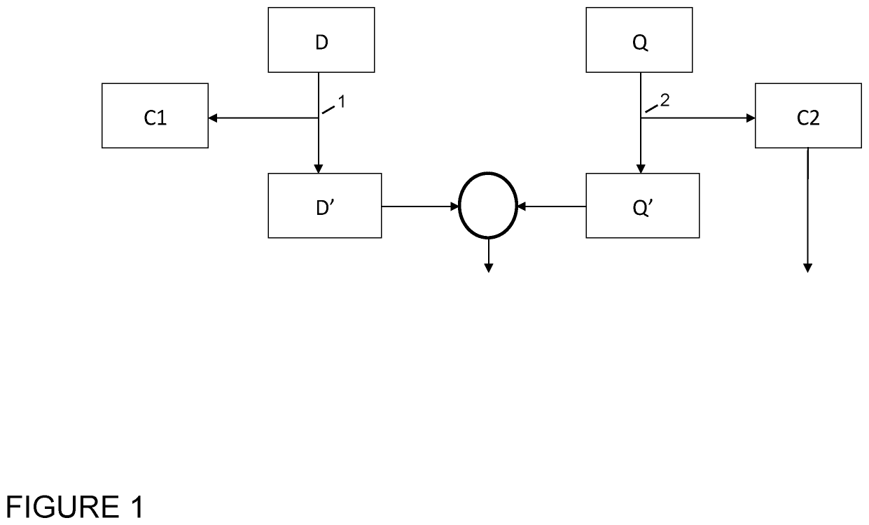

With reference to FIGS. 1 to 4, D is a dataset, D′ is a structured dataset, Q is a query, Q′ is a structured query, C are contexts, and the circle refers to a structured database.

The arrows to the bottom represent the output and the arrows show the flow.

With reference to FIG. 1, the top left shows an interpreter ‘splitting’ (1) a dataset D into a structured dataset D′ and a context C1. A second interpreter is working on the Q→Q′+C2 split (2).

In our example, the interpreter has split the raw input of houses being registered into a structured dataset (D′) that we can download and a context, C1. The context is then hidden. In this case it contains, for example: “Murton (town, row 23568) looked funny to me, I thought Murton was in London so I've updated fields accordingly” or “Had to get datetimes to ISO for the SQL database—chose DD-MM-YYTHH:MM for that—HH:MM=00:00 is correct due to ‘Purchase of Houses Act 1983’”, however that context seems to reside entirely in one/many (over the past 20 years the data has been recorded) employees' heads at the Land Registry. Of course, the importance of either bit of information is very much dependent on the query—in the Bristol branch of Foxton's estate agents neither will make any difference (assuming they will never analyse house prices by hour of day or in London), whereas in the Merton branch the former point certainly will.

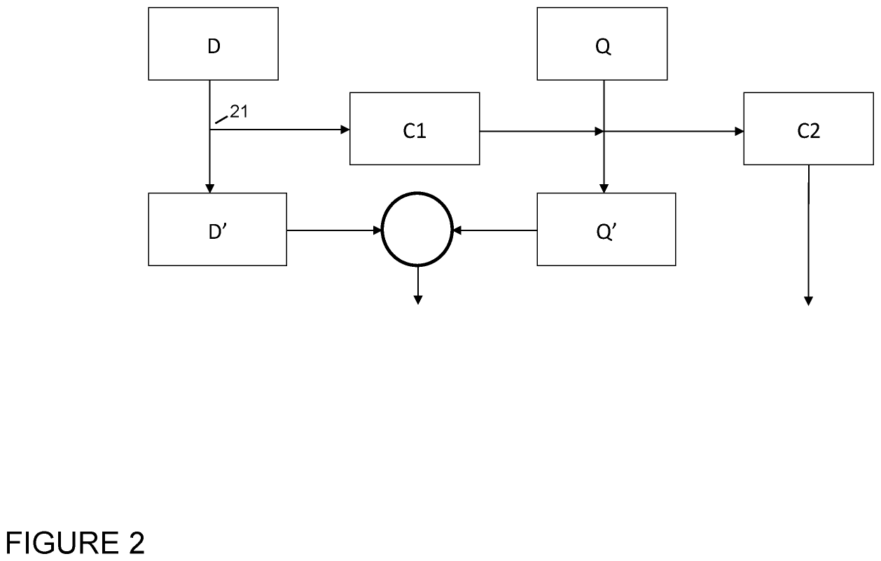

With reference to FIG. 2, the interpreter has provided (21) a dataset context (C1) along with the structured dataset. However, the D-interpreter has a problem as to how much information to include in C1—is everything, even the second point on ISO dates, needed? For most of the UK even the first point is pretty much irrelevant. If he included all he could of the dataset context it would become equivalent to just sending across D, except prone to omission and error in the processing. Because of a lack of knowledge of Q, or of the interpreter of Q, the interpreter of D is taking a shot in the dark of what goes into C1 and what remains in his local context, which we will call C3.

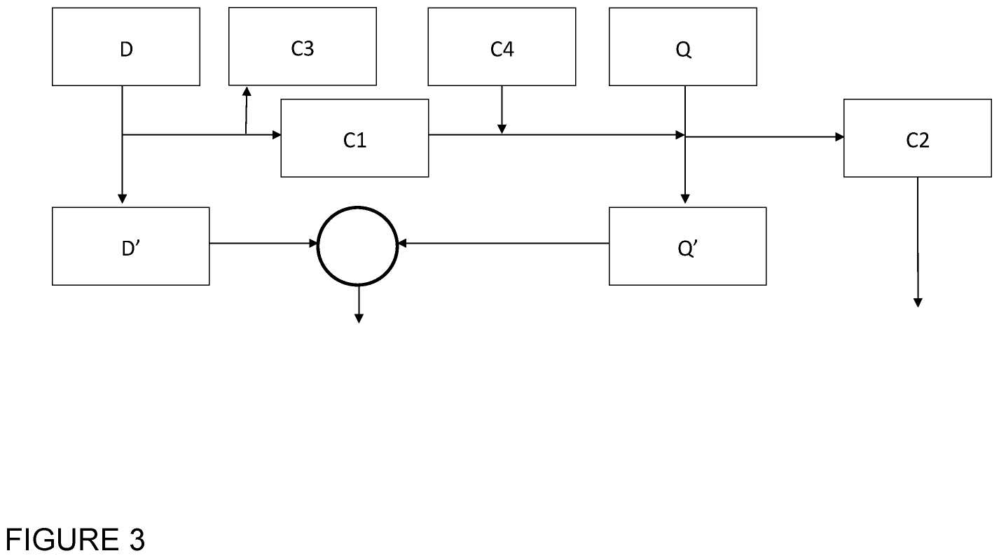

In reality, something like FIG. 3 will have to occur—the second interpreter will have to bring some new context (C4) to the dataset context to try to interpret it in line with the query, and has to hope that no important parts of C3 are missing in his C4, or that he makes no erroneous inferences where none should be. What is more, because of the loss of the information into C3, the query interpreter cannot hope to assess the chance that the result of the query is correct to feed into C2.

In essence the second interpreter is, due to uncertainty in the contents of C3, having to try to guess from D′ and C1 what D probably was, then re-interpret that probable D in the context of Q to get a new D′ and Q′. This obviously has a lot of room for error, and also is inefficient and not scalable, nullifying the point of cleaning D→D′ in the first place.

The two main problems are:
The first interpreter does not know what to put into C1 since they don't know Q. This means the second interpreter will almost always need to interpret D′ again.
The second interpreter does not know the size/content of C3, and so is flying blind in any trust of C1 and may not be unable to complete their query or, worse, include unseen errors.

There are ways round this problem:
The first and second interpreter work together to get C3=C4 or effectively to modify C1 for the context of Q: e.g. the query interpreter phones up the land registry and has a chat “Oh yes, I thought Murton looked a bit funny, thanks, I'll change that”. The problems are that:
   This quickly leads to many different versions of D′ stored by each of the numerous query interpreters working with the Land Registry data around the country.
   It does not scale well, which is what the conversion for D→D′ in organisations is meant to achieve.
   It really just means they are the same interpreter, working together to interpret D in the context of Q, but the query interpreter is doing the typing.
Ensure that C1 is complete—i.e. C3 is null. However, this nullifies the point of making D′ in the first place. C1+D′ is just as complex, but now has more room for error.

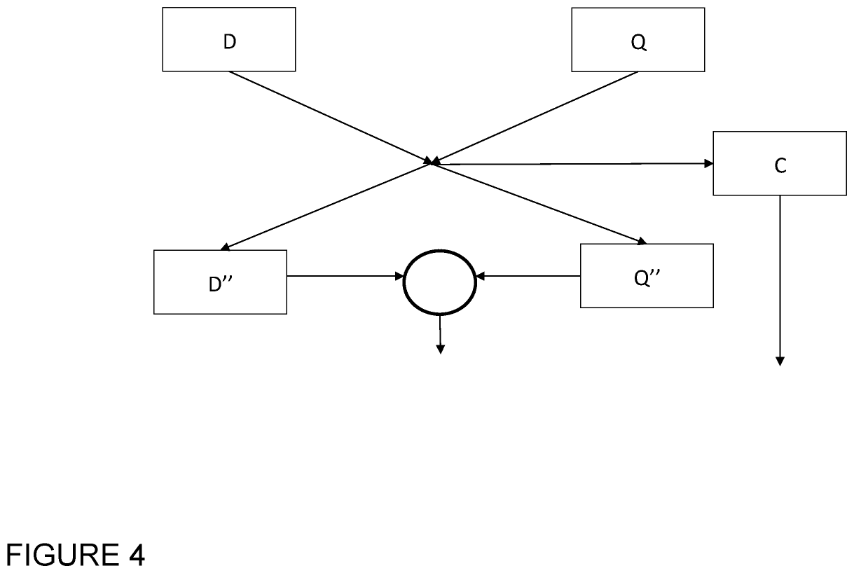

An implementation of the invention solves both these problems by using a single interpreter with knowledge of both D and Q: C, which replaces C1 and C2, is constructed and known internally to that interpreter. The setup is shown in FIG. 4.

At a very high level, the system dynamically manipulates the dataset in response to a query. The query acting on one or more datasets triggers the creation of a structured query, a structured dataset and a single context. This process is being performed by a single interpreter. This contrasts in particular with the scenario where a dataset is interpreted by a first interpreter to a structured dataset and a context, followed by a second interpreter (possibly taking into account some or all of that context) interpreting a query to a structured query to act on that structured dataset, along with a new context. An aspect of the implementation hangs on the use of a computer implemented interpreter, otherwise the criticism of scalability remains. However, for a computer the time to run the query and the time to perform the D→D′ and Q→Q′ transformations are very similar. This is unlike a human, where the transformations are the bottleneck.

At a very high level, the system's scalability is therefore obtained by removing human elements from the processing of the dataset and from the processing of the query since the interaction with a dataset by a human is constrained by the time taken for the human to interact and the time taken for the machine to perform the query, not the time which would be taken for the machine to replicate the human's interactions. Hence, the scalability of the system may be as good as if a perfect dataset cleaning followed by distributed query translation model were used.

To explicitly show what happens in our system in the current example (see FIG. 4): The first interpreter we discussed (the person cleaning the dataset at the Land Registry) does not exist—the Land Registry would just upload their raw data, which would be downloaded by the user of our system (forming D). They would then ask a query (Q). At this point the system cleans the data D, forming a context (C) and D″ and Q″.
This means that in the case of Bristol estate agent asking questions about “average price in Bristol by postcode by month”, neither of the issues with Murton or the T00:00 would occur. So the context of a query affects how D is cleaned and hence affects D′.
In the case of the Merton estate agent asking a similar question “average price in Merton by postcode by month”, the problem previously was caused by a hard-to-find error in the cleaning. This error would now not occur, and the underlying ambiguity (that the full data for some properties in Merton was not filled in by the person entering the data and had to be erroneously filled in by the interpreter at the Land Registry making D′) would be flagged up, being more obvious in the raw data.
In neither case would the second point arise, since the T00:00 has never been introduced. Anyone interested in finding out about the legalities of buying time, or wanting to answer a question such as “number of houses sold by hour of day” can answer those questions using a more suitable dataset having not been misled by the process of cleaning to D′.
In each case due to the fully recorded creation of D′, Q′ and C, other datasets can easily be brought in or joined to provide validation and therefore supplement the context—for example the Murton/Merton problem could be further investigated by looking at other UK geographical datasets to understand if there are other features of the house price records (the street name for example) which can unambiguously identify the properties as being in Merton/Murton.

In each case, the context provided to the user and the answer are directly related to the query and the dataset, making the minimum number of assumptions, therefore providing the minimum possible scope for error or confusion. This is due to the fact that the context and answer give a complete account of the actions of the system, and the queryer has complete control over the system's actions. A single interpreter has complete visibility of the system and can be held entirely accountable for whatever actions are performed. This contrasts with a scenario where cleaning of the dataset and the translation of the query are performed by different entities, neither of which can be held accountable or have its actions verified by the other due to loss of information.

We now move on to describe the computer implemented interpreter in more detail.

A probabilistic interpreter (which we shall just refer to as an interpreter below) is an interpreter which creates a series of possible {Q′, D′, C, Answer} with different weight/chances attached to them, allowing a ranking.

A probabilistic interpreter builds up a set of instructions as to how to proceed to create the list of {Q′, D′, C, Answer}, when seeing a query Q and dataset D, based on at least.
Properties of Q & D
Properties of previous Qs & Ds
Properties of other currently visible Ds.

The Interpreter creates multiple possible sets of {Structured Query, Structured Dataset, Context, Answer} each with an associated probability. The probabilities are formed from a combination of probabilities local to individual aspects of the interpretation, from global properties of the interpretation, from a combination of probabilities local to the particular query and dataset and from probabilities from a stored knowledge of the interpreter.

At a very high level, the query is processed by an interpreter that aims for intent, not query, resolution. This contrasts with other solutions which provide an answer which satisfies the query asked “to the letter”, as it is often their stated aim and is often achieved by enforcing that aim even when it ignores a user's clear expression of intent, allowing no error in either understanding or execution by the user asking the query. This rigid enforcement of a meticulous response to the query asked provides a barrier to non-technical or non-expert users trying to query a database. Even after having rephrased their query into the language required by the database they are using, where concepts which are quite simple to think or express in natural language are often very difficult to write (for example a question like “Which London borough had the largest increase in house price in 2015” is difficult to ask a standard, SQL, database, yet very easy to write and understand in English), they can still be defeated by a single error, a misplacement of a space or comma for example, in executing the query.

Multiple Answers allow an interpreter to iterate its understanding of the user's Intent.

Multiple Answers are presented to the user, which may be used to:
Confirm or deny an inferred part of the Intent,
Teach the user about ways to express Intent/Queries,
Teach the user about possible modifications to improve their Intent,
Teach the user about impossibility of their Intent,
Teach the user about the Dataset(s).

Based on the user's interaction with the possible answers, the Interpreter can refine:
Its understanding of the mapping of the current state of the Dataset/Query/interaction history to Intent,
Its behaviour having inferred a given Intent.

Only one answer could be returned, however this would significantly hinder the Interpreter's ability to learn off the user's behaviour, as well as the user's experience. The interpreter uses but is not limited to:
Learning based on previous inputs and behaviour
Rule based behaviour—protocols for given sets of inputs—predetermined e.g. spotting outliers on columns, frequency analysis, enforcing pedagogical behaviour
Rule based behaviour—protocols for given sets of inputs—explicitly set by the user
Built-in datasets, which the user does not necessarily know about (e.g. pre-loaded geographical databases)
Explicitly, the interpreter is not just based on learning

In human terms the probabilistic interpreter is learning what the queryer's intent is through its repeated interactions with them. The better the alignment between its understanding of the user's intent and the user's actual intent, the better the experience for the user.

As stated above, intent is what the user wants to see. This is not necessarily what they have asked for, verbatim. This distinguishes our approach from a standard analytic tool. Every aspect of the user's interaction with the system is part of the intent—what datasets they interact with, what they do ask, what they don't ask.

Through continual interaction with the user and learning from their response to the suggestions provided, the interpreter can be updated to provide the highest possible chance of matching the user's intent.

In the event that the user's intent is unclear, either due to the query or the dataset, the explicitly given intent is supplemented by the behaviour of the interpreter. The combination of learnt, deterministic and other behaviours can be simple or sophisticated.

The interpreter infers the user's intent not just from the most recent interaction (for example the query e.g. writing some words or clicking on a graph, and the currently loaded datasets) but the entire history of their interaction with the system.

At a very high level, the system enables the ‘exactness’ of the input from the user to scale with ‘exactness’ of the intent. Hence, if the user has a broad intent, they can express this, if they have an intent which is a very explicit query they can ask this. The remainder of the work to make Answers and Contexts from the intent expressed by the user and the available datasets is performed by the interpreter. In contrast, no matter what the user's intent, current analytical systems force them to construct a structured query, often having to add extraneous information which is not what they actually wish to ask

### Examples of Intent and the Behaviour of the Interpreter

We begin with the house price example, before moving to another fictional dataset to provide further examples.
1) The Foxton's estate agent in Merton brings in the house price data and the user at the estate agent asks “price by month”. The system returns a number of suggestions satisfying that intention, for example “average price by month”, or the property with the highest price by month, “highest price by month by postcode” etc.
2) We note that here he wants things to do with price by month, this is his intent, and this is what he asks for. In an existing analytical system, he would have to supplement his actual intent with further information or instructions, and structure a query around it. This presents a barrier to a non-technical user for whom having to convert “I want something to do with price by month” to “SELECT AVG(‘price’) FROM ‘table_houseprices’ GROUP BY MONTH(‘date’)” is challenging. Actually, he doesn't particularly want the average price, and it is obvious to him that he is referring to the only date column in that dataset, but the insistence of existing solutions on a close-to-structured query forces him to put in this information.
3) While the query is being typed, the fact that Murton and Merton are similar is seen in the autocomplete, and then while aggregating by postcode in the last query the fact that some postcodes are significantly different, with a very different history of prices is noted and returned to the user. Here the computer's superior analytic and pattern spotting ability along with an ability to quickly rationalise and form judgements across large amounts of data comes into play.

Now another example:
4) The user brings in a set of sales figures for June 2014, having previously bought in a set for May 2014. The sales figures contain ‘profit’, ‘units sold’ and ‘county’, and are loaded into ‘sales_figures’.

| profit | units sold | county |
|---|---|---|
| 1000 | 7 units | Bedfordshire |
| 2050 | 2 | Nottinghamshire |
| 231 | 2 (good sale) | Bedfordshire |
| . . . | . . . | . . . |

5) The homepage, or the result of a null query can display the answers associated with making a reasonable guess that his intent in bringing in the 2014 sales figures is to form similar KPIs (Key Performance Indicators) from the June set as he did from May. We have inferred an intent solely from the interpreter's stored knowledge without any query entry from the user, merely extracting the intent within their import of that dataset.
6) The user then types ‘Bedfordshire’. We return answers based around the user's previous actions when looking at Bedfordshire in May's sales figures.
7) The user types ‘Northumberland’—he's never typed that before—but since it's in the county column like Bedfordshire, we perform operations similar to those for Bedfordshire but for Northumberland (e.g. Average profit in Bedfordshire→Average profit in Northumberland).

Note the contrast with the closest ‘exact’ structured queries for 5, 6, 7 which are: for 5 something like “SELECT * FROM ‘sales_figures’” i.e. just show the table, for 6, “SELECT * FROM ‘sales_figures’ WHERE ‘county’=‘Bedfordshire’”, and for 7, “SELECT * FROM ‘sales_figures’ WHERE ‘county’=‘Northumberland’”. These indeed capture the translation of the query to a structured query in the context of the dataset, but are far removed from the eventual intent of the user.
8) He now aggregates the units sold by county—“number of units sold by county”.
   a. He's never done this in the sales figures before, but in some delivery records he was looking at a few days ago, he made sure to aggregate all of Yorkshire (North, South, East Riding and West) together as one. Therefore, when he now types “average profit by county” the system returns both the simple “COUNT(‘units sold’) FROM ‘sales_figures’ GROUP BY ‘county’”—the closest literal structured query, and, “COUNT(‘units sold’) FROM ‘sales_figures’ GROUP BY ‘county’ (with all Yorkshires set equal)” and flags this up.
   b. But unfortunately we actually want ‘units sold’ to be treated as an integer here, not as a string column (despite the comments written alongside the numbers)—at the moment we're doing something like “number of towns by county”. Again the interpreter lines up the use of “number of . . . ” with the previous behaviour of that phrase in queries, with the contents and title of the ‘units sold’ column, and comes up with a good probability of ‘number of units sold by county’ meaning “SUM(‘units sold’) FROM ‘sales_figures’ GROUP BY ‘county’”.
   c. Here, again, we are using previously learnt information to try to better infer the user's intent rather than exactly interpret their query. The four responses (COUNT/SUM and Yorkshire split/not split) involve different cleaning of the dataset, different interpretations of the query, returning different contexts and different answers, with differing probabilities.
   d. If the interpreter is well aligned with the user's intent, these responses will be ordered correctly.
9) He now asks for “average maximum profit by county”—that could well mean “AVG(MAX(‘profit’) BY ‘county’)” but we know from previous interactions on a variety of different datasets that he uses it to mean “average and maximum profit by county”. The system behaves accordingly. This is a very local example of intent in the interpretation of NL leading to the formation of a local probability.
10) He asks for the profit aggregated by region. Region isn't in the sales figures—and is in a fair number of other datasets—but he's previously used “region” in other queries to refer to “Region_Offices_2” in the geographical base data his company uses. The system attempts to perform a join to that dataset. If he hadn't have previously used ‘region’ it would still perform joins to other datasets, but with a flatter probability distribution across them.
11) Imagining a dataset with ‘date’, ‘type of fruit’, and ‘store’—“Average and maximum profit in Nottinghamshire in 2016 for lemon grouped by store”—here, it is clear that the user has a specific, and well formed intent—he's never asked that question before, and it seems sensible. Here only very related insights based on similar structured questions asked previously should be returned.

Other examples are given:

Creation of context with and without a query being entered:
12) A dataset about US presidents contains three columns—‘president’, ‘inauguration’, ‘lines of speech’—the middle column (which contains years >=1789,<=2017) could also be a 4 digit integer. The query ‘number of records by decade’ causes the ‘inauguration’ column to be understood as a year and the query, binning those years into decades, to be performed. ‘lines of speech’ could also be interpreted as a year, but the probability would be far lower (since the lengths of the speeches are generally nowhere near the usual range of years) and so ‘inauguration’ is selected.
13) Say the data also included a column ‘town of birth’. These can be inferred to be in the US by the place names all belonging to a set of US town names, and therefore a new context—that these are US towns and therefore have the (lat, long) associated with them, from which maps can be created.
14) In the case that there are misspellings or other uncleanliness in the data, the context can be used to infer the correct interpretation—for example misspellings in the list of town names can easily be corrected by their context, or while joining to another imported dataset during the analysis.
15) Playback to the user allows the context to be iteratively confirmed/modified based on the feedback from the user. For example, they may want the town to be ‘misspelt’, for example if it's the correct old name of the town, but this would not destroy the interpretation of the column of years.

Continuing to use a stored or iterative context
16) That context, that ‘inauguration’ is interpreted as a year, is stored. The fact that inauguration being a number should be interpreted as a date in future (with a high probability) is also stored. Therefore, when a dataset relating to Columbian presidents, say, where coincidentally the speeches tend to be around 2000 lines and so the ‘lines of speech’ column is much more year-like is bought in, that ‘inauguration’ rather than ‘lines of speech’ should be cast to a year is inferred.
17) If ‘president’ and ‘town of death’ were in a dataset, the association of a geography with the president column would cause a high probability of those towns being interpreted as being in the US even if there were ambiguity.
18) Answer always given: there always exists at least one Answer given the presence of at least one Dataset. At least one Answer is returned no matter how low its ranking by the Interpreter.
   Anything gives an answer.
   A precise question: ‘Records where the town of birth is Shadwell’
   A question with context which has to be derived or recalled: ‘Number of records by decade’
   A question which is expressing a general intent:
      ‘By decade’—show how the other columns change on a decadal timescale;
      ‘Average lines’—queries which give insight around the average lines in the speeches—presidents from which town have the highest average lines of speech, has the average number of lines increased or decreased over time, . . . ,
      ‘Place of birth’—where were most born, presidents from which town have the highest average lines of speech, . . . .
   Note that different expressions of intent can lead to sets of queries which overlap being run
19) Even if the context is in fact inaccurate or the question is not really related to that particular context, an answer will still be generated, though the probability assigned to its correctness will be lower (which can be flagged to the user), for example “Iron manufacturing in Missouri” in this case will return the records for the presidents born in Missouri, along with feedback to the user that the words “Iron” and “manufacturing” are uncommon words and are not found in the dataset.

Additionally, the answer ignoring the interpreter's internal understanding is returned first, in order to avoid the failure mode that the user actually has the intent they have perfectly expressed in their query which may however seem very unlikely to the interpreter.

A null query also gives meaningful results. The datasets are interpreted using the interpreter's stored knowledge from e.g. previous behaviour.

At a very high level, the interpreter handles both content generation and display. The answers include both the data and its presentation and the context, which itself includes presentation to another entity. Hence, the presentation of the content is treated on the same level as the generation of the content. Particularly, with a dataset and without a query, a ‘homepage’ is created, where the manner of display of the information within the dataset is particularly important.

### 1.3 A Different Metric of Success for Data Analytics

This system makes the exploration and visualisation of data as easy as possible for as many people as possible. The metrics by which we judge the product are different to those used in competitive products and drive the unique technical solution. This allows us to make progress and innovate in what might appear at first glance to be a full or saturated research area.

Key aspects of the system are the following, but not limited to:
The user's intent is answered, rather than only the precise query asked. Null or partial queries are treated in the context of previous behaviour and previous knowledge as to the intent. This contrasts with other solutions where only a precise query is allowed and gives only a precise result.
The cleaning of the data and interpretation of the query forming a single context enables a single piece of software performing the cleaning in a bespoke manner to resolve the query and/or intent provided by the user. This contrasts with other solutions where multiple pieces of software are used, and/or multiple steps using different, disconnected, parts of a software product are performed, and therefore multiple interpreters are involved.
Multiple results are returned and suggested, enabling therefore a highly iterative experience. Every inferred intent causes multiple possible insights based around that intent (more than one of which may be correct or useful), and those answers can be interacted with and modified by the user by anything from zooming in on a graph to pulling out parts of the method used to create it. The system tries, through repeated interaction with the user to refine its and the user's understanding to be as close as possible, this gives the best chance of properly judging the intent of the user. This contrasts with a user being forced to input a single precise query which the computer then interprets to the single precise result where both the answer and the method are locked to that precision.

This is achieved by cleaning the dataset and translating the query to create a single context using a single interpreter. The system therefore responds to the intent of the user (determined through the learning of the interpreter, taking hints from previous and current interaction of the user, the organisation and the world with the system) rather than their specific query being asked/dataset being analysed at that one time.

The interpreter therefore creates, uses and stores the context for rapid retrieval and modification. The context may include the dataset context and query context as defined above. The context is continuously updated and improved as the system iteratively resolves a query/intent provided by the user with further user input. The record of the interactively generated contexts can also be used between datasets, sessions or users to inform future query results, learning, on a local and global scale.

An innovation here is the realisation that we must have an entire system optimised and designed from the outset with that goal in mind. Many products could argue that they try to solve one of these problems. We have realised that the only way to solve them is to provide an integrated solution to all of the problems, substantially simultaneously.

Technologically, we have to provide an entire, integrated and consistent solution. Because of this, the vast majority of the code that is described here is proprietary and has significantly different functionality to other products in the field.

The different parts of the system are highly interconnected in order to optimise the system for the best response(s) globally (in contrast to a modular approach, in which at best local maxima can be found, even if parts of the system can operate probabilistically): for example, a natural language engine in the system can predict how interesting the results of multiple potential interpretations of a query will be to the user by firing several through the database, and it uses these results as part of its method to determine the best interpretation(s) it outputs to the user. When it is unclear to the system what the best outputs are, various options are given, allowing the user to iterate quickly to the desired result.

This implementation is a method of analysing data in which the data includes one or more raw datasets which have not necessarily, in whole or part, been cleaned for the purpose of facilitating querying and are in that sense ‘imprecise’, and queries which are not necessarily structured to conform to a structured querying language or protocol and are in that sense ‘imprecise’; and in which an imprecise query triggers the creation or recall of a new or different dataset from the imprecise raw dataset, the new dataset being a modified version of the imprecise raw dataset that permits or facilitates querying by the imprecise query.

The method is not limited to only “imprecise” datasets and queries, and may also be generalised to analyse structured datasets from structured queries, or may use any combinations of structured/unstructured data and query.

Another implementation is a system that includes an interpreter or probabilistic interpreter, a database; and a user interface to accept queries and display answers, such as charts, maps or other information, operating as an integrated system, where the system automatically processes (e.g. cleans) the dataset and processes (e.g. translates) the query simultaneously or in a linked manner, so that processing the query influences the processing of the dataset, and/or processing the dataset influences the processing of the query.

Optional features in an implementation of the invention includes any one or more of the following:
Each part of system is highly interconnected, providing a global optimisation of the problem across all active elements of the analytical process i.e. the result from each part of the system is used to determine most likely answer from the various options.
The system creates a range of viable options, “suggestions”, given the inputs provided by an end-user and/or the data available in the database or dataset and in real-time chooses a number of most interesting suggestions to display.
The provision of these suggestions to the user in real-time as their intent and understanding of the dataset is better understood contrasts with the usual method of forcing the user to exactly resolve any ambiguity in their intent before the information is fed back. The user is involved in the global optimisation problem along with the other computational elements of the system.
The system creates multiple potential results and uses a variety of metrics to rank the results in order of validity. This ranking, both in the metrics and the process to produce the ranking, is modified and can increase in complexity and relevance with user feedback.
The system works probabilistically, such that it chooses the best output(s) from a range of different options based on their relative likelihood.
The system is able to join data between any number of datasets as it does not require that they adhere to the same type or specification. This allows the system to understand the context of a dataset in relation to every other dataset in the system, hence removing the need for human oversight.
The ingestion of data is probabilistic, in terms of the inference of its encoding and structure.
The database holds the imported dataset which is stored in raw, unaltered format. This means no information is lost on import such that connections between two (or more) datasets may be found in cases where, had the columns been reduced or strictly typed, it would not have been possible.
Indexes of each column are stored in a reduced form, such that lookups are of constant time and are approximate by default (e.g., “ile de France” and “ile-de-france” are stored as the same entity).
Databases reside on an end-user device or an external server.
Databases are automatically designed to be easily queried.
The user interface understands highly complex and nested queries (which, e.g., map to tens of lines of SQL with multiple JOINs).
Native handling of imperfect queries to the database is implemented, with no attempt to generate a precise representation of the intended query—instead, queries are probabilistically modelled.
The same entity parsers are used for processing the dataset and for processing the query (e.g concept of time/geography is consistent throughout the system). Hence the system recognises the universal concepts of time and geography using the entity parsers. Additional entity parsers can in principle be added to account for any other shared concept (e.g., hierarchies within organisations).
The system is able to recognise synonyms, and does so in a probabilistic way.
The synonym matching process is also inherently fuzzy or imprecise or probabilistically modelled.
Data parsing includes automatic inference of character sets and separators/table structure, as well as the ability to parse other machine readable formats, databases and multiple files.
The database automatically structured to handle imprecise queries and imprecise datasets.
Fuzzy NL inputs are used as direct inputs into the system—i.e. there is no gateway to the database demanding precision (e.g. no requirement for queries to conform to a Structured Representation of a Query (SRQ) language), as is normally the case and the pipe carrying NL inputs to the database imposes no constraints on the form of the outputs (e.g. no requirement for answers to conform to a particular structure).
The end-user receives updates on progress and success of parsing on various simple metrics—e.g. determination of the file separators, concatenation of imported tables.
Despite the system's inherent ability to operate approximately, an audit trail is maintained such that the end-user can see exactly what calculations have been performed.
The end-user is able to readily override assumptions made by the system, if necessary.
Incomplete statements where details are implicit in the question, requiring context of the data, can be understood (e.g. ‘rate of change of price by town’ involves implicit concepts of time and the aggregation of price).
The processing of the query allows the constraint that the query inferred must be a valid one on the dataset in question to be directly included in the parsing of the sentence.
Feedback at multiple levels is enabled by the performance of the database and the interconnectedness of the system—from autocompleting queries to help the user phrase their query, to the suggestion of further queries.
The system generates a query match that is a probabilistic maximum from a set of probabilistic maxima that each are a function of the individual components of the query and/or the interactions between sets of individual components of the query.
Each element of the system sends and feedbacks inherently fuzzy or imprecise or probabilistically modelled data.
Potential interpretations of a query are used to query the database and a ‘best guess’ is outputted to the end-user.
The ‘best guess’ is a probability maximum generated from multiple parallel processes that generate a set of local probability maxima outputs from all of the various subsystems or processes or sets of subsystems or processes.
Despite working probabilistically, the system resolves to an exact solution with a precise audit of all calculations and assumptions made from start to finish. This contrasts with the usual method, where a series of entirely deterministic assumptions (often effected using multiple products or systems) are performed and tracked manually making these decisions difficult to track, reverse or communicate.
The system iteratively resolves ambiguities by prompting for and capturing further user input until an output is generated (e.g. a visualization) that is as precise as the datasets allow.
No human oversight is needed.

Whilst a NL front-end represents one key use-case that is discussed here, the following description and examples can be generalized to any use cases where inherently ambiguous datasets are interrogated or explored. Hence, any reference to a query or a NL query can be generalized to any type of query as defined above.

### 2. Details of an Implementation

The following sections take us deeper into an implementation. References (§) in this section will refer to subsections of ‘2. Details of an implementation’. For example, 95 refers to section 2.5, and §§ 3.4-3.5 refers to sections 2.3.4 to 2.3.5.

### 2.1 Overview of an Implementation

### 2.1.1 Nomenclature and Implementation

The functionality of the application—aside from the interaction with the user and the display of the visuals—is provided by the program Bethe, which is written in C++. It connects to the front end by using Chrome's V8 runtime engine, which underlies Node.js (nodejs.org). The rest of the code in Bethe is proprietary and bespoke, using no libraries beyond the C++ 11 standard (which is supported in its entirety by all major proprietary and open source C++ compilers). As such, in the context of discussing components of Bethe, “Bethe uses” or “we use” does not hide the use of an underlying library in which any patentability and/or intellectual property could ultimately reside.

The vast majority of the material in the technical description of the document relates to Bethe, with the exception of parts of § 5, which relate to the front of the app. This is written in JavaScript and is used in the app with the help of Electron (electron.atom.io), which wraps a mixture of HTML, CSS and JavaScript into a desktop application.

### 2.1.2 an Example of User Interface Workflow

Here we show an example of how this would be implemented for a user. The user can move in any order through this process, however we describe the three stages here in the natural order for a simple use of the app.

### Import Page:

Here the user brings in the datasets they wish to use.

Front of app, § 5.1: The user drags and drops or pastes in a file/buffer (or, extending the current UX, opens a connection to a database, which may reside on the user's computer or an external server). The user is informed of the progress and success of parsing on various simple metrics, e.g., the determination of the file separators, as well as more complex metrics, e.g., the concatenation of the imported tables. In the progress of that they are shown a sample (e.g. top 10 lines plus the headers) of the table or a representation of the spreadsheet sent by Bethe. If mistakes have been made by Bethe these are then rectified by the user (for example, the separator can be changed and the file re-parsed).

Bethe: For machine-structured data (e.g., delimited text files or database extracts), Bethe uses the techniques in § 2.1, and for human-structured data (e.g. Microsoft Excel spreadsheets), the columns/data are identified using the parsers (Appendix A) and the preparation described in § 2.1.1 and § 2.1.2 is performed. The conclusions are relayed to the front of app, which then displays them to the user.

Result: The files have been loaded into the database and are ready for the user to query them.

### Edit Page:

Front of app, § 5.2: The tables can be seen, columns created, global filters applied and manipulation and cleaning of the data performed.

Bethe, §§ 3.4-3.5: here the database must create new columns, edit their values, perform SQL-style queries and help with cleaning.

Result: A table is now ready to be explored.

### Explore Page:

Front of app, § 5.3. The user experience (UX) is driven by natural language with feedback at a word and phrase level. Charts are displayed along with the interpretation of the query and suggestions.

Bethe: Interprets the queries (as described in § 4), providing feedback on the named entities and associated values (such as dates) and responding to feedback. Performs the queries, automatically joining. Makes suggestions based on the current tables and previous behaviour.

### 2.1.3 Example Workflow

Here we show a sample workflow, to give a more concrete idea of what the user experience is in a simple case. While this does not show all features of the system we describe, or of a product based on it, it should serve as an indication how the system is used in practice.

Our user, working in a medium-sized UK company with offices around the country, is interacting with an implementation of the system in a desktop app. She decides to have a look at comma-separated values (CSV) files containing a list of employees first name, last name, office, date joined, region, productivity and salary from 100 offices, in 100 separate files. She drags and drops the files onto the import screen and they are imported. The app detects that they are similar and concatenates them—if they weren't, she could modify that and re-parse.

She is first taken to the “home page” of the data she has brought in. She actually has a specific intent as to what she is looking for—her intent is to look at the performance of John Smith relative to that of the other employees—is he providing good value?However, she finds the homepage useful to remind her of the columns in the dataset she has brought in and what their contents are and to see a few overall metrics. Since she has previously brought in an older version of this dataset, a few months ago, one of the streams on the homepage replicates some of her earlier queries.

She sticks with her original intent and first types “John Smith”. This gives her the exact result—a list of people with first name John and last name Smith—along with a number of other visual insights about the productivity, salary etc. within that group.

There are obviously several John Smiths in the company, and so she moves to the list of people. Based on her query and previous behaviour (having judged the column contents), the interpreter has formed a name column from the first and last name columns—she accepts this, adding it to the table. She wants the John Smith from Swindon and so clicks on that entry, she also wants to ignore interns with very low salaries and so applies a global, persistent, filter to the salaries column (excluding salaries below £10,000). The app flags up that one of the salaries is 100 times larger than any others—she corrects that error. It also flags that “date joined” has been assumed to be an integer—the dates are written as YYYYMM—201503 for example—and the interpreter has erred on the side of caution—she ignores that, since she's not looking at dates, and also ignores a couple of flagged up possible name misspellings since they're irrelevant for her intent.

The “John Smith” query now has a locked “Swindon” token appended to it and is now returning the exact result—the Swindon office John Smith's record—along with insights about John Smith in the context of the other employees in the Swindon office and in the West England region. She selects the graph of “productivity by employee in West England” and sees John Smith in context, followed by clicking on an insight in the sidebar and looking at Swindon's average productivity in context of the “West England” region. In general Swindon is less productive, but equally, she thinks they probably get paid less there.

To explore that, she changes her query and asks: “productivity salary” (in fact she types “productivity salry” but the autocomplete corrects the spelling). As well as the exact result, several other visuals are provided, including, near the top, “productivity and salary and office”—the interpreter flags up that this was highly ranked because “office” causes clustering on that graph, showing that “office” is a reasonable predictor of the relation between “productivity” and “salary”, whereas the graph with “region” instead of “office” has no real pattern. She realises that she should probably therefore look at John Smith relative to others in his office and really ignore the region—it not being as important. She zooms in on the Swindon office on the “productivity and salary and office” graph—which therefore restricts the insights to the Swindon office and other offices with similar salaries and productivities. Due to her previous queries regarding John Smith (Swindon) his point is highlighted on the graph.

She quickly exports the chart that she initially needed—John Smith has a reasonably high productivity for his office relative to his salary—so that's good news—but overall Swindon's productivity is low. Since she was looking at the Swindon office, the interpreter contextualises this to the West England region—“average salary and productivity by office in West England” is returned in the sidebar of the larger visual and the interpreter flags up that Swindon is a low outlier relative to other offices round there. This will be something to bring up with the West England manager.

To help aid the visual impact for that discussion—despite it not really being crucial—she asks to see the “average productivity by office in West England” and selects a map-type plot. The interpreter automatically joins the office names to its internal database of UK towns and plots those points on a map with different size points for the productivity in each office—which makes a nice slide. Since a fair amount has been done behind the scenes she quickly checks the method the interpreter has returned—the table of data looks reasonable, and the fuzzy join again has been done properly. She sees that the global filter is still on though and turns that off in the method since it would complicate the story for the West England manager—the map automatically updates.

This is not something she would have been able to make without the support from the software since she would have had to have found the data for the towns, fuzzily joined the offices to the towns (“Swindon Office”=“swindon”) and then plotted it on a map, which is well beyond the technical ability of an average business user.

She now returns to Swindon and decides to look at the 20 employees there—is it a case that the longer-term employees like John are simply getting lazy? She looks at “productivity year” and filters for Swindon. “date joined” was previously being interpreted as an integer—to respond to this query the interpreter dynamically ‘re-cleans’ the dataset with the knowledge that a date column is present (i.e. it now recognises 201503 as March 2015) and flags up this change in the method it returns to her. The “average productivity by year of ‘date joined’” graph shows a general rise with time—the younger people are keener—she looks at John in that context . . . .

Here we have shown a subset of functionality, including:
Import of data, automatic concatenation.
Display of a homepage providing information about the dataset and linking back to previous behaviour.
Processing of expressions of intent at various levels of exactness from “John Smith”/“productivity salary” to “average productivity by office in West England”
Continual iterative refinement of the user's intent and the interpreter's understanding of the user, allowing better insights to be returned.
Retention of previous user interaction even when the user's intent changes significantly to help continuity of the exploration (highlighting John Smith's point on the chart, for example).
Autocomplete/spelling correction based on the dataset.
Insights returned which enhance the user's understanding of the technical characteristics of the dataset, for example by providing an assessment of clustering or outliers.
Automatic joining to a hidden, library, dataset using fuzzy joining where this need is inferred from the chart type. This is re-cleaning of the dataset to match the office column to the town column in the mapping data which has been triggered by a query which consists of the typed question asked, plus the choice of map as a chart type.
Automatic re-cleaning of a dataset in response to a question with no other intervention from the user, even when the user had the opportunity to perform that cleaning themselves earlier—the presence of “year” in the query has caused a large change in the state of the interpreter.
The method used is returned to the user to provide confidence and can then be edited.
The user is able to produce charts and insights in line with their intent without the usual limitations of technical ability.

### 2.1.4 Further Applications

The technology discussed here could be applied to many other problems.

The discussion in this document has immediate relevance to many problems in the modern business environment in which a user interacts with a system or database through an interface, prime examples being document management systems and version control systems. Such systems are often in fact a database, however they are not transparently implemented as such to the user.

Considering both the premise of producing an accurate, quick and high quality result with little expertise and the natural language specifically, the techniques used (discussed in § 4) again have a broad applicability. We are not “using NL to understand a sentence” but rather “using NL to translate the sentence into a plausible database query” which is what makes the problem tractable. In addition to routine or structured tasks in the office environment, this approach could be used to control machinery or other systems with a known set of outputs, particularly providing at least a simple level of functionality to a non-expert user—“using NL to translate the sentence into a plausible system behaviour”—while not needing software bespoke to the system, just as the software here is not written for a single dataset or data source. In the case of data analysis, the software discussed here is unlikely to entirely displace a skilled data analyst, and in a similar way we would not expect an entire displacement of skilled control of any system.

A good example is provided by a safety system in a heavy mechanical setting which could use the ideas presented here to allow a person untrained in the usage of a specific piece of machinery (an attending fire-fighter for example) to obtain at least a basic level of control over it. If they needed to perform a simple task quickly, for example making the main component move in a specific direction to avoid further injury; the unstructured nature of the NL queries, the software's learnt behaviour based on previous usage of the system, flexibility as to the language of the query and concepts analogous to the implicit understanding of time or number (§ 4.1.2) would be beneficial.

A system that allows people to ask complex questions of a large number of datasets enables multiple propositions in a number of areas, such as:
Data analytics software: Analytics software that allows individuals to gain insights from data that are currently very difficult to acquire, given the need to curate the data and query in a structured manner.
Enterprise-scale analytics platforms: An analytics platform that incorporates uncurated data across an entire organisation and allows all employees to query it.
Analysing data within the IoT: Further extension to complex queries across the inherently disparate and large datasets within the IoT.

Other examples of applications are the following:
Virtual assistants: Our natural language interface could provide virtual assistants with the ability to answer far more complex queries than is currently possible, allowing users to query datasets they come “in contact with” in real time (e.g., from “what's the weather in London?” to “how much hotter is it today than it was last Tuesday when I was in New York?”). This would enable deeper, real-time and more flexible virtual assistants.
Virtual or augmented reality: Beyond natural language, our technology could be used as a means to explore data in a virtual or augmented reality environment, where inputs are similarly ambiguous and users expect near-instantaneous results to queries while retaining their immersion in the VR/AR world. Hence, the probabilistic database query system would be a key for an immersive and fluid experience analysing data in VR and AR.
Valuation of datasets: The ability to identify how a single dataset links to all others within a system, including the number and strength of each connection, allows for:
   Datasets to be valued beyond a naïve metric of size, through for example their cleanliness, their connectivity to other data, and their timeliness (for example if news reports that fish stocks around the UK are declining come out, the value of the datasets relating to those stocks to a larger section of government, industry and the media will suddenly increase). The technology we are building is therefore an essential building block of a data economy where datasets could be bought and sold at scale.
   The identification of which data need to be added to an existing collection of data in order to increase the combined value, either to be sold commercially or to be used within an organisation. This leads to a differential value of a given set of data to different users at different timesa, leading users to wish to value their own data for sale or exchange for other data which they find more valuable, creating a market with the opportunity for complex instruments and speculation (for example buying datasets which you think will soon become timely in line with world events).
Identification of relationships between data sources: by being able to optimise the way organisations are structured and work by identifying relationships between data sources and concepts which haven't because of a lack of direct computational (e.g. join, concatenation) or organisational (e.g. knowledge of their existence or value out of their home department or ‘silo’). This is enabled by the significant increase in speed and scope of the system relative to human inspection.
   For example: the system could route-find through all datasets of an organisation, open data, and potentially datasets in other organisations and notice that there is a relationship between dept. A with dataset a to dept. C with dataset c because of a connection through dept. B and dataset b. This could encourage collaborative working between depts. A, B and C as the impact of each on the other could be better understood and optimised.
Inter-machine communication: Currently strict protocols and standards have to be promulgated and enforced (e.g., HTTP/FTP); our technology would facilitate the communication within/between IoT-type systems using non-human language. The inherent flexibility provided by our technology allows two systems to communicate without having to have previously agreed a predefined “strict” protocol between them and for the systems to become increasingly efficient in communication as their shared context evolves.
Intra-machine communication: Continued development of the concept of ‘memory’ in AI systems will be aided by our technology providing a memory which could be queried by multiple systems at speed, flexibly and with correction for incorrect phrasing of queries (particularly during systems' learning periods).
Quantum computing: While the underlying technical solutions will necessarily be very different, the experience from our technology and product in understanding how to provide the user experience when the user is interacting with an underlying system which is performant and probabilistic will be highly relevant.

### 2.2. Import

Any data analytics product which aims to provide a full user experience for a non-expert must address the problem of importing data without requiring the user to intervene. Data divides broadly into two categories:

I. Machine structured data—this is generally quite simple to import.
II. Human structured data—this is often much more complex.

We recognise that speed is a key function to provide the user with confidence and insight. For large tables and servers this means importing a sample of the data so a user can identify key insights, then running the full query on external database.

### 2.2.1 Import Machine Structured Data

The system interprets machine structured data by considering the likelihood of an individual entity's interpretation based on how well this fits with the interpretation of the other entities in the same column.

Machine structured data is easy to retain in such a format—for example, a CSV file is already a table. The challenge here lies in interpreting the entries.

Software for doing this currently is not very good—for example, Microsoft Excel (Excel) interprets each cell on an individual basis such that for a CSV file containing

. . .

### 50A1

### 50B1

### 50E1

. . .
in the same column, 50A1 and 50B1 are interpreted as strings and 50E1 as 500 (a float).

Also, having done that, it will not allow the conversion back to a “50E1” string. This may seem a contrived example, but this is precisely the problem with data cleansing—such examples require significant time and effort to find and rectify.

The ability to import machine-structured data reliably, and in a highly automated way, has a huge number of further applications across many areas of technology.

### 2.2.1.1 Identification of the Character Set in Use

We must identify the character set in use. There are hundreds of different encodings of various sets of characters which are used around the world.
I. We run a filter for restriction to ASCII and test for UTF8, UTF16.
II. We discount encodings which can not produce the byte-string we are provided with. For example if we have a string of three bytes, {a,b,c}, then if b≥0xA1 (hexadecimal) but neither a nor c is, the text can not be the GB2312 character set for simplified Chinese characters in the commonly used EUC-CN encoding.
III. We use diagram frequencies (obtained from analysis of corpora from the different languages) to try to distinguish between European character sets.
IV. In the case of ambiguity (often between European character sets if little text is provided), we provide the user the ability to select the character set in use. We can suggest the most likely since many will have been ruled out by I and II or will be very unlikely by III.
V. We learn from previous interaction and locale—if the user often imports in a certain character set, or has declared themselves located in a certain country, we weight that option preferentially.

### 2.2.1.2 Identification of Separators and Table Structure

Tables to be imported are stored in various formats—the separator between the columns, the number of columns or rows and the presence of a header row are obvious to a human. Current database software often suffers from poor import capabilities, dominated by a single default behaviour (e.g., always assume a header row and “,” separator).

Bethe automatically identifies the size, separator and header row in a table with high accuracy.
I. Separator—4 separators (comma “,”, whitespace “ ”, tab “t” and semi-colon “;”) are supported. We determine which one is the separator by calculating the mean and the variance of the number of occurrences of the symbol in each row and prioritising those with a low variance and high mean.
II. Header row
(a) First we look for changes in the type of the entry (e.g. integer, float, range, date, string or other column type). The header is assumed not to be present unless it is seen to be there.
(b) We look for changes in the format of the entry—for example integers are parsed with a prefix and suffix, and therefore

| | 2009 | 2010 |
|---|---|---|
| August | $200 | $300 |
| September | $300 | $400 |

will note a difference between the {, 2009,} and the {$, 200,}.
III. Provide a facility to the user to swiftly declare a header row present or to change the type of a column.
IV. Learning from previous interaction. Again (see § 2.1.1 IV), if one particular type of file is often imported etc.

In summary, and as is the case with much of the database program, the default behaviour is not a single, defined behaviour, but rather to use the most sensible settings given by evaluation of a set of simple, defined metrics. This provides a significant increase in the ease of importing data, removing a barrier to entry for non-technical users and inconvenience for a technical user.

### 2.2.1.3 Import Other Machine Readable Formats

Using the techniques above other machine readable formats, e.g., JSON, JSONstat, XML can be read in. These formats are generally newer and with a higher level of standardisation.

2.2.1.4 Import of Tables from Machine Databases

A command of the form SELECT * FROM <table name> will return the contents from a database table, which can then be treated in a way very similar to a CSV, with the added benefit that column types and other additional metadata are known.

2.2.1.5 Import of Parts of Tables from Machine Databases

We will often not want to import the entire table from a database due to security, bandwidth or memory constraints.

In the case of security constraints this must be decided by the user. For the other cases, we take a random sample of the database and use this to perform the operations described in the rest of this document. The SQL feedback (§ 4.8) can then be used to control the remote database to perform the ‘final’ query.

### 2.2.1.6 Import of a Streamed Data Source

Often data is not provided in a static file.

Keeping the data constantly indexed automatically is key for the general user experience.

A streamed data source of a given format can be read in to a series of buffers, as is a normal file. The buffers are then parsed and the values appended to the appropriate columns. If a column is made ready for streaming we have two options:
An unlimited column. After an initial length is allocated, the column is moved to a column twice the size when that space is exhausted. This results in a number of copies which is less than double the column size. For integers, floats, etc., the addition is trivial; for strings the indexing can be performed in O(1+fn) (where n is the number of rows in the column and f<<1) timedue to the design of the index (§ 3.1.1).
A limited column. Here the memory is declared and then as the buffer for the column is exhausted, we begin writing again at the start. We have to dispense with a sequential character buffer, however changes to the indexes are again O(l+fn)—i.e. fast. This can use aspects of § 2.1.8 to try to correct for errors in the input stream either in type or interruptions. The buffer can provide some latency.

Queueing of the incoming buffers can be performed using the Javascript front end, which is well designed for handling such structures. To solve the queueing problem in general for an incoming stream of data, a larger database-based solution, for example MongoDB (mongodb.com), is required. Practically, the speed of import into Bethe is faster than a high-speed internet connection and so such import problems will be confined to large organisations where existing system and security issues are likely to eclipse the technical challenge.

### 2.2.1.7 Import of Multiple Files

Many pieces of data are spread across multiple, similar files—for example the data for each month or for each county are stored separately; usually for reasons of being able to transfer the data and open it in table-size-limited programs. Bethe provides automatic multiple file import capabilities.

To enable the files to be imported, we must provide the following.
I. Scalable import routines, for n files each of size m, we want the time to import to scale with the product nm, i.e., that it is read as quickly as if it were a single file. This is provided by reading in the tables separately and then performing a final concatenation.
II. Automatic recognition of which columns can be concatenated and automatically performing such a concatenation using, for example, and not limited to,
   (a) the position,
   (b) the type,
   (c) the format of the columns,
      which are used to define a metric.

### 2.2.1.8 Checking for Errors During Import

In the process of import, errors in the files can be detected and flagged for correction by the user.

Flagging for type errors and spelling errors come as a corollary of the indexing process. We can also consider the distribution of ordinal values to detect outliers.

Potential issues with data based on odd distributions of different columns may be flagged to the user, such as: gaps in an otherwise continues distribution of numbers; very large outliers; combinations of two different entity formats. Also relevant to providing suggestions.

### 2.3 Database Functionality

The system provides the functionality required so that the user can obtain the results they require from the database.

### 2.3.1 A Quick Primer on Databases

A database must perform a few basic functions.

Perform simple queries

SELECT x FROM y WHERE z GROUP BY a ORDER BY b

We select columns x from table y where conditions z are satisfied. We group by a and finally order as specified by b. When we find an entry or number of entries satisfying z we want it/them to be found quickly—if there are 1 million entries it takes time to look through them all. There are various ways around this—we discuss ours in § 3.1.1. The same applies to grouping, which is discussed in § 3.1.2.

### Join

TABLE 1
Names and salaries of employees.

| Name | Salary |
|---|---|
| Alan | 1000 |
| Chris | 2000 |

TABLE 2
Names and surnames of employees.

| Name | Surname |
|---|---|
| Alan | Benson |
| Chris | Davidson |

What is Davidson's salary? For Davidson, we look up Chris and then find Chris's salary. This is joining the two tables. However, often the tables are larger, more complex, more numerous (and chains of joins through the tables are required), do not match exactly, have duplication/ambiguity. Setting up the joining in those cases has typically been the preserve of data scientists—we give our solution in § 3.3.1.

### 2.3.1.1 Indexing, Compression and Searching

In order to achieve the required user experience, queries must be as fast as possible. Two techniques are used to speed the interaction of the database with the data.

### Indexing

We use a hash-table index to allow fast access to individual records or groups of records.

The method is:
I. Convert the text to the nearest ASCII representation (using conversions from the CLDR, cldr.unicode.org), make it lower case and remove non-alphanumeric symbols.
II. Obtain an integer within the range of the hashtable, h, using the output of the murmur32 hash of the lowercase ASCII string modulo h.
III. If, when we hash a string Y from record j to an integer y (0≤y≤h), the hashbucket contains an element, that element is a pointer x to the last list element in that bucket, so we make the link-list element at j point to x and make the bucket y point to j. This leads to an invariant size hash list which automatically fits in the length of the array which can be pre-allocated.
IV. Addition to the column in this case is therefore always O(1).

For a hashtable in general, step IV is not always the case and the realisation that a hashtable such that this is true is needed is important. The innovation in Step I is discussed in § 3.2.

### Compression

We use a combination of a dictionary and a hash-table. The hash-table points to a series of elements which are represented in the column by integers (of 8, 16 or 32 bit length). If the column contains an equal mixture (say) of “YES” and “NO”, these have an average size of 20 bits, but can be represented by a column of 8 bit integers (this being the lowest easily representable number of bytes; an x byte integer can represent up to 2^{x} possibilities, e.g., 256 for an 8-byte integer). This represents compression by a factor of 2.5. The hashtable is then used to point at both the dictionary and the column values.

Compression for in memory and on disk storage using the dictionary and hash-table. Also increases read-in speed from the proprietary format and speed for aggregation. (§ 3.3.1)

This allows a very fast check for existence, which is required for the natural language to be effective (NL, § 4).

Such compression is therefore beneficial to all aspects of the code. This feature is not shared by the more sophisticated, high-compression algorithms used in e.g. bzip, gzip etc.

### Searching

For testing and demonstration purposes, the database has a simple SQL interface, allowing SELECTing a number of columns FROM a table, WHERE conditions are met, GROUPed BY a number of columns and ORDERed BY others. The language used is a subset with slight syntactic differences from the SQL standard.

Compound Searches

A method for enabling compound searches provides an order of filtering and searches are based on how the database is indexed.

For example, IN Lincoln AND price >100000. There are far fewer houses sold in Lincoln than below 100,000 and so it is optimal to apply that filter first (using the indexing) and then apply the second filter on the result. The judgement can be made since the number of elements of each type in many columns is known from the indexing and dictionary process, and the number of numbers to be returned can again be determined from indexing or a knowledge of the distribution.

The search implemented here is as quick or (from testing), quicker than any other well indexed database.

### 2.3.1.2 Grouping

We must also be able to group data according to common features. A method for grouping uses the dictionary and re-indexing on the concatenation of column values.

This is either performed using a compressed representation of the dictionary onto the integers—for example, for three columns with dictionary sizes L, M and N, and dictionary numbers 1, m and n; we can use lMN+mN+n to map uniquely to an integer between 0 and LMN. For high cardinality columns, the database can also use a re-indexing on the concatenation of the column values.

### 2.3.2 Provide ‘Standard’ Database Functionality—Simple Queries

Standard database functionality must be provided, here the advance comes in the choice of the methods.

Databases must be able to perform “simple” queries, in SQL notation: SELECT x FROM y WHERE z GROUP BY a ORDER BY b. We select columns x from table y where conditions z are satisfied. We group by a and finally order by b. All database languages must provide this functionality and it covers many common queries.

The Bethe database provides this functionality, with methods applied to add ease and speed for the user. We try to hide as much of the technical running of the database from the user as possible.
I. Indexing is performed automatically—unlike in many databases the user does not have to define indexes on columns. Many of our target users do not know what one is, and even for technical users the choice is complex. Indexing allows individual elements of high cardinality columns to be found rapidly.
II. The advance in I (above) is that the string comparison is fuzzy by default and therefore very fast. Say you had a list of towns containing “ST. HELENS” and requested “st helens”; a database may
   (a) Return nothing—technically correct, but frustrating to the user.
   (b) Have to perform multiple indexed searches to find “ST. HELENS” by guessing from “st helens”. This is very time consuming, if it even finds a result.
   (c) Look through at all the strings performing a fuzzy string matching. This is O(n) and slow.

The solution in Bethe is to index using a string where as much information has been removed as possible while keeping it recognisable. It is far faster to find a few candidate strings (and is unlikely in most data sets due to the redundancy of language and the precision of codified values) and then check them for equality. Therefore the indexing and the searching is performed on severely de-informationed strings. In this case both “ST. HELEN'S” and “st helens” are indexed (and looked up) as “sthelens” and so the match is trivial. Another example is ile-de-France which is indexed by “iledefrance”-note the lack of the circumflex. Bethe will pick a single “ile-de-France” out of a list as fast as it picks “Ile-deFrance” or “ile de france” out and has been tested to do this in near-constant time on columns with tens of millions of rows.

With suitable internationalisation and transliteration this also allows a significant cross-character-set, e.g. simplified Chinese to Pinyin capability.

Hence, indexes of each column are stored in a reduced form such that lookups are of constant time and are approximate by default (e.g. “Ile de France” and “ile-de-france” are stored as the same entity. This fuzzy indexing enables the fuzzy joining described in the following subsections.

This allows the database to pull out a small number of candidate variables (which can then also be displayed to the user for ‘autocomplete’ or disambiguation) and then check for equality rather than look for the exact variable straight away.

### 2.3.3 Provide ‘Standard’ Database Functionality—Joining

Standard database functionality must be provided, here the advance comes in the choice of the methods.

Databases must be able to perform joins—this is where a column or columns of a table are used to link two tables together. Take, for example, a table with columns “employee” and “salary” and a separate table with columns “employee” and “department”; these could be joined and aggregated to produce the total pay in each department by joining on the employee column.

Joining is usually performed by explicit instruction from the user, however this is unsuited to the use case for our product—it scores highly on a metric of flexibility and exactness, but is completely outside of the capabilities of an average business user. While in the case of simple queries the correspondence between sentences and SQL is generally good, this is not the case here:

“Houses in Nottinghamshire for which the average price in their town is greater than the average price in Lincolnshire”
is conceptually simple, and can be executed by our application, yet is complex to write in SQL:
SELECT * FROM price_paid INNER JOIN (SELECT town, AVG(price) FROM price_paid WHERE county=“Nottinghamshire” GROUP BY town HAVING AVG(price) > (SELECT AVG(price) FROM price_paid WHERE county=“Lincolnshire”)) AS b ON price_paid.town=b.town WHERE county=“Nottinghamshire”
(where the SQL table name is price_paid).

Making a query with joins in is complex and involves a good understanding of database semantics.

Bethe provides joins by performing them automatically. This is done by a route-finding algorithm.

The fuzzy joining algorithm uses a combination of global and local variables to optimise across entity, column and dataset. It consists of continual refinement of the best guess join.
Matching of individual entities
   Exact, or very close (e.g. different case/punctuation) matches are found
   At this point, if an exact join exists it will have been found in optimal, O(n), time.
   Approximate matches are found
Matching within a column/columns
   The global problem between the columns, or between the remaining elements of the columns which have not been exactly matched is solved using dynamic programming techniques to attempt to achieve as close as possible to O(n) scalability.
   The algorithms allow a simple feedback from the user in that they can define a given match as true even if the matching by the internal metrics is poor or vice versa throw out a seemingly good match
   The matches are ranked, and displayed to the user. This is important since a failure which is displayed to the user as good (e.g. is a long way down a list of possible errors below many valid matches) is likely to be missed. False positives are therefore significantly more destructive to the user experience than false negatives.
Matching between multiple datasets
   Based on the metric of goodness of the fuzzy matches found, the best joins are determined
Matching through multiple joins
   Once those joins are determined, finding the ‘path’ between datasets with no direct join is a classic route-finding problem

Fuzzy joining on-the-fly allows data to be stored in an unclean form. This means no information is lost, and a single source of truth is maintained.

Fuzzy joining allows the system to find dataset relationships upfront and improve the depth of insight offered up to users without their involvement more efficiently than if only exact joining were available.

Approximate joining between datasets is highly optimised and scalable. If new datasets are added the user can quickly be informed of possible joins to the existing datasets. By always storing the shortest length between two datasets, as is required anyway by standard algorithms for the matching through multiple joins, this extends trivially to multiple joins, as described in the following section.

### 2.3.3.1 Route Finding for Joins

Given various tables, we must find routes through them which allow the tables to be joined.

Due to the number of tables being relatively small, this is solved through a dynamic programming method. The overhead involved in finding the possible join between two tables is large and so this is stored when found. We also store the shortest route between any pair of tables—this allows an incremental change in the join (e.g., by the addition of another table) to be effected quickly.

Joins are found by performing a fuzzy match between two columns or two groups of columns. This match includes
I. Fuzziness as regards the character set—this solves the problem of joining an Anglicised table to a table in a native language.
II. Fuzziness as regards spelling.
III. Fuzziness as regards the precise membership of each column.
IV. Fuzziness as regards the number of columns, for example a Name column in one table may need to match to the First Name and Second Name columns simultaneously in another table.

Geography uses similar techniques to this, however with some more preparation of the geography database having been performed.

These factors are weighted together to provide a metric of the goodness of the join; and then the best join is made; or in the case of multiple chained joins the join with the best product of metrics for the different joins.

Fuzzy joining, and, though fuzzy joining a column to itself, fuzzy aggregation, is key functionality in a product trying to remove the burden of data cleaning.

### 2.3.4 Creating Columns

This is technically straightforward.

The only challenge in this is speed, which is naturally limited by the complexity of the operation. For example, performing an exponential moving average on time series data might involve a pre-sort of the data, or pulling apart a string will take longer in UTF. In a similar way to the searching this is optimised as much as possible.

### 2.3.5 Disk Based and Other Databases

Most databases are disk-based; in-memory databases are gaining popularity due to the increase in speed and the increase in availability of high memory machines. This increase is nullified if swapping or hard faulting occurs.

In Bethe:
I. The indexes always reside in memory—this allows very fast indexed searches.
II. The dictionaries for lower cardinality columns reside in memory—this allows fast tests for existence and numbers of elements.
III. The database handles the memory rather than allowing the operating system (OS) to handle the swap. With the benefit of modem hard disks and taking advantage of the column-based nature of the database, the decrease in speed is present but not too large.
IV. We therefore extend all the ideas discussed here to the case of any disk-based database that does not degrade the user experience.

### 2.3.6 Caching

The database caches full queries without any limiting of the number of entries returned from the table to allow fluid browsing of results (e.g. a data table view where the user scrolls down).

Bethe implements caching of the results of queries and what the queries were.

This is used to:
I. Provide quick responses to the same query or to requests for different parts of the data returned by a query. For example, if records 0-100 are required, the other records, 101-967(say) are cached and so can be returned very quickly if required. This is used to supply scrollable tables to the front end.
II. To provide a starting point for further queries. For example:
   (a) If the user wants to refine a search, we can begin from the previous search results.
   (b) If we want the same results but sorted, the search need not be performed again.
   (c) If we have already sorted a list and want to filter it, in some cases (typically for filters which return a large sub-set of the existing list) it is fastest to perform the filtering on the pre-sorted, cached, list.

The cache has a specified size (e.g., 5 elements) and is emptied in order of when the element of the cache was last used. In web-based applications this capability is supplemented by the caching on the reverse proxy server, which does not offer the contextualisation here, merely returning results of exactly identical queries to those already made.

### 2.4 Natural Language and Feedback

Natural Language (NL): Take a string of words and provide a query of the database corresponding closely to the users intentions for the session interacting with the database. The key to this technology is the recognition that this is not the same as providing the best possible parse of a given input, rather we want a parse which robustly maps to a valid query, is non-pedantic, is well justified/explained and provides a solid jumping off point for future queries.

Our metric is therefore significantly different to that used in much of current NL research.

Feedback: This provides a key component to the NL and to the working of the product as a whole (though, since the NL is the primary means of interaction for the user with the database, much of the feedback centres around that). As discussed in § 1, a mainstay of the method is to make high-accuracy guesses as to what the user requires. Feedback allows the user to confirm or reject the assumptions the app has made allowing erroneous assumptions to be corrected in the short term and learning to occur in the long term.

The broad program is to firstly tokenise the sentence, then to find the query best corresponding to the sentence and perform it. However, at each step the inclusion of feedback allows us to move backwards and forwards through this process.

### 2.4.1 Tokenise the Sentence

### 2.4.1.1 Helper Parsers

We use a series of helper parsers to provide specialised handling of named entities, operators and dates. This tokenises a sentence:

“Average price by town in Lincolnshire”
quickly to:
[operator] [column—numeric] by [column—word] in [element—county]

This is where the database technology is enabling—we must have a very responsive database to allow elements to be identified in a high cardinality dataset and we must identify them in a fuzzy way to avoid pedantry.

The helper parsers which handle in addition operators, dates, numbers and geographies are modified for differing locales.

### 2.4.1.2 Specialisations

I. We use an extension of SQL in that tables can be created and embedded in the query with the automatic joining functionality (§ 3.3.1). For example:
   NL “Houses in Nottinghamshire for which the average price in their town is greater than the average price in Lincolnshire”
   SQL: SELECT * FROM price_paid INNER JOIN (SELECT town, AVG(price) FROM price_paid WHERE county=“Nottinghamshire” GROUP BY town HAVING AVG(price) > (SELECT AVG(price) FROM price_paid WHERE county=“Lincolnshire”)) AS b ON price_paid.town=b.town WHERE county=“Nottinghamshire”
   (Here price_paid is the table name.)
   With extensions: SELECT * FROM price_paid WHERE [AVG(price), town FROM price_paid GROUP BY town]>[AVG(price), county FROM price_paid WHERE county=“Lincolnshire” ] AND county=“Nottinghamshire” This is significant because we have maintained
   (a) the structure
   (b) the ambiguity
   from the human sentence when moving to the query.
II. We also record the position of the term in the sentence—this is used to determine joining and remove ambiguities (see III).
III. We have the concepts of IMPLICITtime and IMPLICITdate. Say, for example, the house price table has a single date column “date”; “houses sold after July 2015” should be mapped to SELECT * FROM price_paid WHERE date >July 2015. A more sophisticated approach is taken in that the query is first parsed to SELECT * FROM price_paid WHERE IMPLICITtime >July 2015 which is then evaluated to date at query time using the relative position in the sentence to determine which table that implicit date refers to. IMPLICITnumber works in a similar way and allows us to resolve many problems with vocabulary. For example, the house prices has “date”, “price”, “town” and “county” columns. “Show houses purchased for greater than 100000” makes no mention of price. The thesaurus may help, but ultimately due to the column formats, SELECT * FROM price_paid WHERE IMPLICITnumber >100000 also works.
IV. Learning from IMPLICIT use—this therefore allows us to connect the word “purchased” with the “price” column above the thesaurus, and therefore allows us to adapt to the usage of a particular person.
   2.4.2 Support Interactions with the Entities

We provide a consistent experience in that the same parsers are used in the database as in the NL. This means that if a date is recognised in the table then it will be recognised in the NL.

This may sound obvious, but in many programs the parsers used are different for different parts of the program—this leads to an inconsistent experience—for example a date is recognised in the table, but can then not be interacted with, or as discussed with the fuzzy matching, a foreign word is rendered, but can then not be searched for.

### 2.4.3 Tokenise the Named Entities

We must solve the problem of recognising what is an operator, column, record, date, etc. We assign a weighting to each word and phrase in the sentence as follows. Say we have two phrases A and B with lengths a and b. We begin with two numbers, W₁=1 and W₂=0. Consider each word in A:

I. Does it match a word in B?
II. Is it after the previous matched word?
III. How important is it that it is matched?
III is determined using a weighting w=exp(−[f+g]), based on the fractional frequency of the word in the Brown corpus, f, and the frequency of the word in the table itself, g. The value assigned to a word if it is present is v=(1+w) and v=1/(1+w) if not. If w>1, W₂ increments by 1, and W₁ is multiplied by v in all cases.

The output is then W×W₂/[max(a, b)×(1+0.03ab)].
Why? W₂ expresses how many words have matched, W₁ expresses how good the match is: If a rare word is missing, w>1, v=0.5 and so the change in score for adding that rare word to the test string is about a factor of 0.5—that word has significantly hurt the match. If the word is moderately common and matches breakeven occurs, since W₁ increases by 1 and W₂ does a little bit, however the addition of a word such as “and” at the end of the string leads to a decrease in the score—otherwise we over-tokenise the sentence. The small (0.03ab) factor is again introduced to try to overcome this, favouring a compact token.

We emphasise that the choice of the formula and parameters here is determined from testing, seeing that sensible behaviour is produced.

Other uses of this scheme would include tokenisation in many other fields. Other people have solved this problem in various ways in the past; the value here would likely come if people became used to this being the “usual” method of tokenisation and so modified their behaviour.

2.4.4 Decide which Entities to Start with

Using the methods in § 4.3, we have given ratings to the entities in the sentence. We begin with the highest rated token, which is accepted. If that token overlaps with any lower-rated tokens, they are ignored. We then continue this process with the next highest rated, still existing, token. We then inform the UI of which tokens have been accepted, which have been ignored and their positions.

### 2.4.5 Provide Feedback as to the Named Entities Word-by-Word

If an entity is initially wrongly named it will lead to either failure of the parse, or that the overall parse takes longer due to having to catch the error at a later, more complex stage. Allowing the user to see and interact with the named entities is therefore a first line of defense against an unsuccessful parse.

Here, again the database is enabling technology in that the named entities must be quickly interacted with by the user. The advance is in this speed of interaction combined with a good UX.

The sentence is tokenised by the NL routine so that individual words and phrases are recognised as being related to the table or operators and other database commands. Each phrase is given a rating by § 4.3 and the most likely initial parse is produced by § 4.4. The decisions made by the NL are then encoded (as 0 for not-accepted, 1 for accepted), passed to the front-end and displayed to the user, when 3 interactions may occur:
I. The user can leave the parse as is—it will be default accepted/not-accepted
II. The user can explicitly accept the parse (giving it a flag ‘2’).
III. The user can explicitly change the parse to another option (giving the new option a flag ‘2’ and explicitly rejecting the existing parse with ‘−1’).
IV. The user can modify the text within the parse (giving it a flag ‘−2’—the user did not reject the parse, merely change it).

I causes no change; II raises the weighting assigned to that word, in the current parse (to a value higher than any weighting the NL can give), in the parses in this session referring to that table (by a small factor ˜1.1), and in its parses in future (by an even smaller factor ˜1.01); III does the opposite to II, with higher weights (see below); and IV causes a re-parse of the entire sentence using the new text.

Note how IV is given a different flag and causes no change in the weightings. This is because of logical inference—the parser is using a sentence and parsing technique S to imply a parse P; S⇒P. The inverse of this is, contrary to popular expectation, P [symbol] S (not P—S), which means only rejections of the parse are useful for learning. II goes against this and hence is included so that learning can still be achieved in situations where rejection may be uncommon—this is intentionally designed to mimic human reinforcement learning and make the application seem more friendly.

### 2.4.5.1 Autocomplete

Autocomplete is implemented throughout software applications on desktop and mobile. We use it here to show the user quickly the options available.

Our implementation of autocomplete is necessarily similar to others. However, in our particular case there are various additional advances, challenges and points of interest.

We implement a basic autocomplete functionality as the user types. This has some special features:
I. We can determine the quality of the autocomplete and stop it after a given time: for small datasets the autocomplete can be performed by brute force; for larger ones, the fuzzy matching to the word beginnings is important. We can control this behaviour using asynchronous callbacks in Node.js.
II. We can weight the autocomplete based on the surrounding words—this is because we have more information than in a typical autocomplete, that is, we do not just have a dictionary of words but also have them categorised into columns.
III. As the user types, autocomplete suggestions are shown showing one and multi-word autocomplete, fuzzy completion (i.e. where the words closely match more than one entity), or contains (where multiple entities contain the word/s provided) against the entities in the database. These can be selected and are then inserted into the text input bar. (4.5)
IV. Since the entities are identified as the user types (rather than just as Enter is pressed for example) the presence of the entities can be fed back and also helpful modifications (not limited to summarisation or abbreviation of the entity).
V. Entities in non-ASCII characters can be interacted with through their closest ASCII representation.
   2.4.6 Parse Strings of Words in a Way which is Flexible Enough to be Useful

Much of people's interaction is made up of sentences which are agrammatical, vague, assume knowledge the computer cannot have or are technically structured. The parser must provide the best parse of such sentences in a way which maximises our metrics.

Current NL techniques are tested against a fundamentally different metric, namely the reproduction of parts-of-speech (POS) tags and dependency trees (DT) of a known, annotated corpus. These parsers are poorly suited to understanding queries in our typical input form—in the wider world, this is seen through ineffectiveness in parsing Twitter text, and represents a known unknown in the field.

Our parser uses techniques which are not seen in other parsers.

2.4.6.1 Performing the Conversion of the Sentence into a Query

We use a probabilistic, rule-based parsing to decide what query a sentence should be parsed to. In the example “Average price by town in Lincolnshire”, the interpretation

[operator] [column—numeric] by [column—word] in [element—county]
AVG(price) WHERE county=“lincolnshire” GROUP BY town
is assigned a high probability. The rules are:
I. Higher probabilities are given for the words being near each other by using probabilities of the form 1/[a+|x₁−x₂+b|]. x₁ and x₂ are the positions of the words in the tokenised sentence and the parameters a and b will vary for different languages. For example, a=3, b=1 provide a good starting point for English. Like other parameters in the model, these can be optimised using machine learning.
II. Higher probabilities are given to sentence structures which are approximately syntactically correct, e.g., that price closely follows average increases the likelihood of the parse, but Lincolnshire prices—average by town is also fine.
III. All identified entities must be used, for example a query not including “lincolnshire”, AVG, price and town is prohibited. Preference is given to parses which do not use entities more than once, although it is allowed.
IV. Queries can be nested—a given group of words is not parsed to an output, rather to another entity which can then take part in future parses—a structure similar to a dependency tree but much more flexible and adaptable. This is allowed by the significant extensions to SQL explained in § 4.1.2 which allows such nested queries to be held in a flexible way with the precise implementation of that nesting as explicit queries of the database deferred to the latest time possible. We also note that in no part of I—III are any non-identified words used.
V. Further tests on non-identified words—some words will not be identified—however we can infer from the positions of the words in the sentence what they must be. For example “Number of r” where “r” is not an identified entity is likely to be a synonym for “record”.
VI. Thesaurus—a specific further test is use of a thesaurus. We use WordNet (wordnet.princeton.edu, a large lexical database of English nouns, verbs, adjectives and adverbs grouped into sets of cognitive synonyms). By calculating the distance between words in this database, we can determine their similarity.
   (a) For pairs of words, e.g. apple and banana, we define M=Σ_{w}1/[d(w₁,apple)*d(w₂,banana)].
   (b) Many metrics, d(w₁, w₂) can be used—WordNet contains a large amount of information on how words are related, as synonyms, hypernyms etc. and the parameters used in the metrics, for example the weight given to synonymy versus hypernymy can be varied over time in response to the user's assessment of the accuracy of parses. A highly technical user will likely prefer little interference from the thesaurus since they will value the parser flagging imprecision in their queries, while a more causal user will likely enjoy the flexibility the thesaurus allows in helping them to reach the expression they require.
   (c) For triplets similar provides a metric of the similarity of words within a given context.
   (d) Using previously known associations from IV and § 4.1.2 IV.

The technology used here could be applied to any problem where the form of the output can be constrained. In this case that we are not “using NL to understand” a sentence but rather “using NL to translate the sentence into a plausible database query” is what makes the problem tractable. Examples might be:

I. Interacting other less ‘obvious’ databases (such as document management systems).
II. Controlling machinery or other systems with a known set of outputs.

### 2.4.6.2 Provide Feedback as to the Query Structure

The system is configured to run and store an interim table for each step of a query execution. This allows audit playback by the end-user and easy re-running based on tweaks.

When the user hits Enter and sends the query, we think we know (through tokenisation and feedback) what all the words are, and have then converted the sentence into a query. We can then provide feedback on how we have interpreted the query.

We provide a template interpretation of the extended SQL:

NL: “Houses in Nottinghamshire for which the average price in their town is greater than the average price in Lincolnshire”

Extended SQL: SELECT * FROM price_paid WHERE [AVG(price), town FROM price_paid GROUP BY town]>[AVG(price), county FROM price_paid WHERE county=“Lincolnshire” ] AND county=“Nottinghamshire”

Templated return: First we find the average price (and county since its filtered by) where county is Lincolnshire—we store this as table 1. Then we find the average price (and town since its grouped by) grouped by town—we store this as table 2.

This provides the following solutions:

I. It allows us to show the user what has been performed.
II. It allows the user to modify what has been performed.
III. It allows us to train the user to use recognised terms.
(a) It points out the need for a lack of floweriness. “Houses in Nottinghamshire for which the average property price in their town is greater than the average price of houses located within Lincolnshire” is harder to parse due to the larger number of unidentifiable and pointless words. Returning text in the language we want the user to use provides concrete examples of interaction.
(b) It trains the user on the most standard terms: “maximum house price by county” rather than “most expensive house by county” which involves a correct inference of expensive—price. [use of subjective terms e.g. “best”, “worst”, “most overpriced house”, . . . ].

### 2.4.7 Provide Feedback on the Actual Data

Once the query has been performed, the result is output visually and the method is described verbally.

### 2.4.8 Provide the Equivalent SQL Query

We can simply expand our “Extended SQL” after the query has been performed and the joins have been seen to be correct for use by the user in a separate, conventional database program.

### 2.4.9 Voice or Written Input

All of the technology here can be applied to voice-based commands, provided that the voice/writing text capability is sufficiently good.

Traditionally the accuracy of the voice/writing to text is a source of frustration, however in our case the information required by the named entities parser and the high speed of the database allows a “dictionary” to be provided to OCR/voice software which increases the accuracy of the parse.

### 2.4.10 Suggestions

Some features of the database or how the database is used in the code enable the suggestions.

Ensuring speed of experience is maintained even when datasets are large within the database. This includes:
a. Use the indexing of each column to produce an estimate of the run time and relevance for queries and use this within the ranking of suggestions to ensure fluidity is maintained.
b. Providing results from queries based on samples of the data for browsing and then running full query once the user has shown interest in a specific chart;
c. Running and caching results of queries which are subsets or relevant based on the user's current query of interest.
d. Running queries on subsets of the data, not on the full table each time.
e. b.-d. Are also relevant when the database is external.
f. “Suggestions” are results returned in response to input from the user—including, but not limited to, the history of their interaction both previously and within the session, the current state of their interaction (e.g. the tables loaded, any NL which has been entered, any click based instruction), and the historical interaction of other users.
g. These are therefore not necessarily the strictly “best” response to the visible or local state of the system.
h. The number of suggestions at any time is typically ˜10, though is not limited to this, with further suggestions being produced on-the-fly in response to prompting from the user. This allows suggestions which are judged to be in some way interesting to the user by multiple different metrics to be displayed simultaneously.
i. This contrasts with existing approaches where a smaller number of suggestions are provided which are more limited in scope, e.g. are trying to give the closest interpretation of the user's current, local state or are giving ‘insight’ with little reference to the user's current state or interaction history.

When the user makes a query, Bethe suggests further queries based on that query.

This is performed by:
I. Using a rule based method—e.g., include time if it is not included, additionally group by a low cardinality column, etc.
II. Giving the user a few suggestions which they can then choose from. This produces rejection, or ranking by the user, which is advantageous for learning (see the end of § 4.5).
III. Learning from which ones they choose based on
   (a) Simple unstructured NN learning.
   (b) Learning based on specifics of the title, elements and format of the column, applying the thesaurus capability on the words.

Suggestions are generated continuously—at any time, the UI can ask for the return of one or more suggestions from an updating list. This is limited by the wishes of the user.

By identifying named entities relating to the dataset or database in a user's input, the system can generate SQL queries which include all or some of these entities, with the possible addition of other entities. The order which the user receives the results is weighted based on metrics including the distribution of the results; metrics of statistical relevance; previous search results both by the user and the total user population; and proximity to the inferred intent of the user.

The more entities the user provides the more specific is the set of options for how these elements can combine in an SQL query. This helps the user very easily narrow down to a specific chart they need with minimal input and at speed.

The system can provide SQL queries which contain only the entities the user has requested, and also provide queries where all or some of the elements provided are included alongside others.

Results can be provided without any user input (i.e. without any user interaction with the input bar at all), or with non-tokenisable input (i.e. zero entities are inputted—an empty bar, random text, “Hello, how are you?” etc.) giving the illusion of the user browsing all possible manipulations of the dataset.

The immediate provision of results from zero or partial input, along with the NL interpretations provided as titles of the graphs allows a user to be vicariously taught to use the product, by aping the examples provided, at their own speed and without formal training.

Interface design hinges on providing end output first and then letting user tweak the early stages of the analytical process to a more precise output iteratively.

An example of what could be learnt is that Usually after grouping on a column synonymous to price and containing integer or float values a grouping by a low cardinality column which is not a geography is common.

The process of constructing the metric. The metric is formed from information including, but not restricted to:
a. Metrics from the individual words and tokens in the NL
   How well does the word entered match the token—e.g. how well is it spelt, how good is it as a synonym
   If a word could correspond to multiple tokens, how do they relate to the data e.g. the cardinality of the containing column
b. Their arrangement in the NL query
   How are the tokens related within the utterance, e.g. if two tokens are connected by a coordinating conjunction they should be considered more as a unit than otherwise.
c. Click-based information supplied
   Has the user used a tool tip to drill-down
   Have they zoomed in on a chart
d. Previous actions of the user
   When analysing datasets with a similar structure, column titles or entries previously, how has the user behaved
   In the last few actions has the user, for example, drilled down into a certain part of the data, or been reapply asking about a given column.
e. Previous actions of an average user
   How have previous users behaved (based on data obtained through testing, online access etc.). For example, if there are columns of longitude and latitude, users prefer graphs with these together, producing a map, e.g. ‘latitude, longitude and price’ rather than having them paired with another non-geographical column e.g. ‘longitude and price’; plotting graphs with numerical codes as an axis is not generally useful.
f. Properties of the predicted and actual result of the database query
   Properties of the result of the query can be inferred before using the database, for example:
      Metrics on an individual column can help infer the interest of the data, e.g. outliers are interesting, so if ‘Column A’ contains an outlier SELECT COUNT(*) GROUP BY ‘Column A’ could well be interesting, but codes (in ‘Column B’ for example) are not so SELECT AVG(‘Column B’) is unlikely to give a useful number. The cardinality of the column, its proximity to a known distribution (e.g. Poisson). What is the title of the column and what are its elements e.g. is it known to be a geographical entity (“town”), some abstract ranking (“rank”, “position”) for example.
      Metrics on pairs of columns—are the columns correlated, is there clustering evident, conditional entropy between the columns, explanatory power of the second column over the first
      Metrics on n columns (n>2)—similar. The number of columns on which metrics can be pre-computed scales as approximately (N choose n) where N is the number of columns, therefore for a small-N dataset we can do this.
      If aggregating, how many groups are expected to be produced, and what are the properties of the resulting values
      If filtering, how many results are expected and how are those results related to the results without the filter applied, how is the filter related to c.-e.
g. Properties of a sub-sampled result of the query
   Applying similar metrics to 2. & 3. above to an actual result of the query, subsampled. Since many metrics essentially involve an average value, taking a sizeable, but far from complete, sample (e.g. 10,000 elements) of a table and then performing the query on it will provide a good estimate of the true value (error tends to scale as ˜1/sqrt(N) so we would expect an error in the metric, provided there are no threshold phenomena, of a few percent. Given that the ranking is not set-in-stone or absolute anyway this would be expected to be sufficient). This takes advantage of the high speed of the database in both search and aggregation.
h. The result of the query itself
   As above but using the actual result. Again the high speed of the database is key.
i. Many of the actions in f. and g. are database queries in their own right and so sometimes the outcome of h. will be already known. However, f. and g. are in general used to approximate h. at significantly reduced computational cost, and in a way which is scalable to multiple simultaneous users.
j. The specificity of the user's query. Changing the importance of the result being a good representation of the input the user has provided. For example, if the user provides only one tokenisable word as a query (e.g. a column name or aggregator, “price”), the system provides a broader range of options of valid queries than if many tokenisable words were provided (“average price in Bedford since 2014”). This allows the system to provide both the functionality of ‘search’ i.e. finding a specifically requested result, and ‘browse’ i.e. providing broad information based on some, possibly quite vague or null, expression of intent by the user, within a single framework.

Each of the subsections above provides a number of metrics, which together form a list {xᵢ}. Some function f({xᵢ}) (lower is better) is used to provide an overall metric on each suggestion which is then used to rank them for return to the user. A process such as f. and g. above is used to quickly approximate {xᵢ} and hence f({xᵢ}), particularly in cases where the value of f({xᵢ} can be lower-bounded and so a suggestion can be shown to be low-ranked and therefore irrelevant.

The function f({xᵢ}) can be approximated by simple choices of parameters which make the ranking good enough to be refined by user testing. The list {xᵢ} can also be used as the input for a machine learning algorithm, this being a classic neural network problem, the neural network being a continuously refined definition of f( ). The initial approximation to f({xᵢ}) being used overcomes the need for enormous amounts of training data before any reasonable results are obtained.

There are a large number of queries which could be produced, since we a sampling from a large space of possible queries on the database. Even restricting to simple SQL queries, this set would be far too large to compute f({ }) in each case. We therefore create the possible queries by moving randomly away from the query believed to best express the intent of the user.
The weighting on the random movement is provided by a first approximation to f({xᵢ}), fₐ, and a temperature T, with P divided according to exp(−fₐ/T).
j. above—browse corresponds to a higher temperature than search.
This is similar to simulated annealing, however unlike normally where the temperature is decreased in a computationally determined manner, and therefore becoming stuck in an undesired local minimum is still a risk; here both the temperature (the specificity of the query) and the boundaries of the search space (a radius around the intent of the query) are determined by the user's actions in real-time with the annealing process to mitigate that risk.

The possible movements can be enumerated and are not limited to:

a. By using only the tokenised entities in the query,
b. By using the tokenised entities and adding to them before making the query,
c. By adding and removing entities before making the query,
d. By moving the entities around within the query.

This includes through b. creation of queries from the entry of no tokenisable entities. These define the radius (c.) around the query's intent.

By way of example, in a dataset containing price of an object and the town and region in which it was bought: ‘price’ with a filter of region=X can provide
a. SELECT ‘price’ WHERE ‘region’=X
b. SELECT COUNT(*), ‘price’ WHERE ‘region’=X GROUP BY ‘price’ [the distribution of price within X]
c. SELECT AVG(‘price’), ‘town’ WHERE ‘region’=X GROUP BY ‘town’
d. SELECT AVG(‘price’), ‘region’ GROUP BY ‘region’
   where this list is by no means exhaustive.

The continuous involvement of the user in defining the intent, the specificity of their intent and, in refining the local definition of f({ }) enables the provision of suggestions to the user in real-time as their intent and understanding of the dataset is better understood.

### 2.4.11 System Workflow

When a raw dataset is imported into the database, the database ingests the raw dataset and stores it as contiguous streams in memory as a column-based database with an index residing on top of it, as described in the sections above. The indexing allows an enhanced user experience by enabling a fast access to individual records or group of records within the dataset.

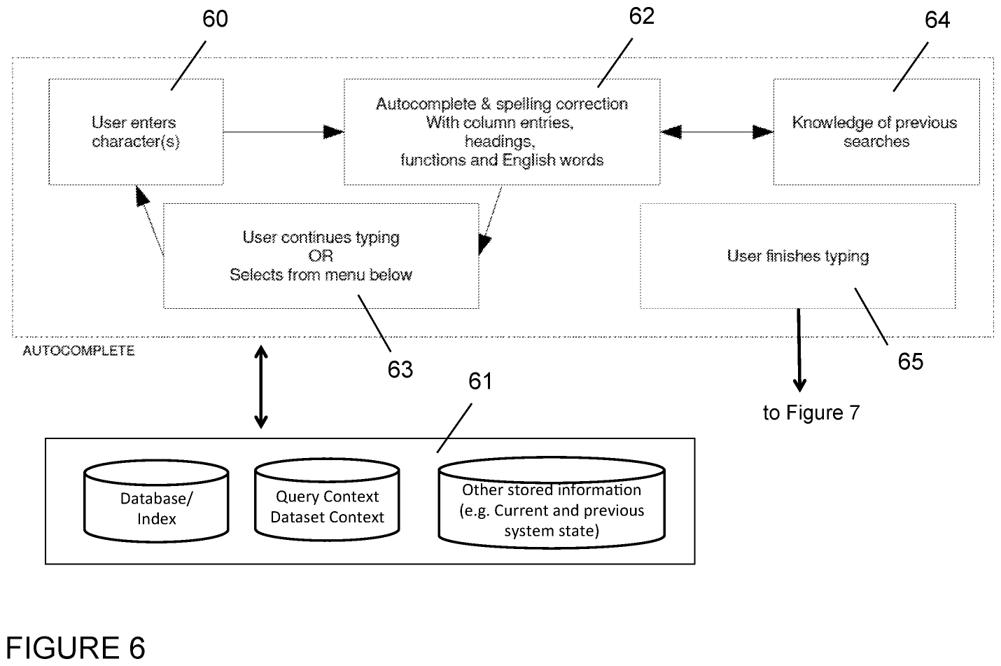

FIGS. 6 to 8 are workflow diagrams summarising the main steps of an implementation in which the database is queried by an end-user.

As illustrated in FIG. 6, an end-user starts by typing a query on a search bar (60). The query and dataset are simultaneously analysed by an interpreter, which creates and stores a query context and a dataset context (61). The query is also processed to automatically generate autocomplete suggestions that are displayed to the end-user using for example a dropdown list (62).

The suggestions that are displayed take into account the query context and dataset context. As an example, the suggestions may be based on the dataset content such as column entries or individual entries, headings, functions (e.g minimum, maximum, rank) and English words. The suggestions may also be generated from the knowledge stored on previous end-user interaction with the system such as end-user search queries (64). The suggestions are then ranked and the top (most relevant) suggestions are displayed on the dropdown menu. The system loops (63) until the end-user finishes typing (65) or clicks on a suggestion that is being displayed. The system continuously learns and updates the database, context and its knowledge as the user interacts with it.

As an example, an end-user may type “average price in Munchester” (i.e. a misspelling of Manchester) and the dropdown menu may display “average price in Munchester (town), average price in Munchester (district), average price in Manchester (town), average price in Manchester (district)”, the end-user may then choose to select “average price in Manchester (town)”.

As another example, an end-user may type “average price by town in Not” the dropdown menu may display “average price by town in Nottingham, Average price by town in Nottinghamshire, Average price by town in not”, the end-user may then choose to select “average price by town in Nottinghamshire”.

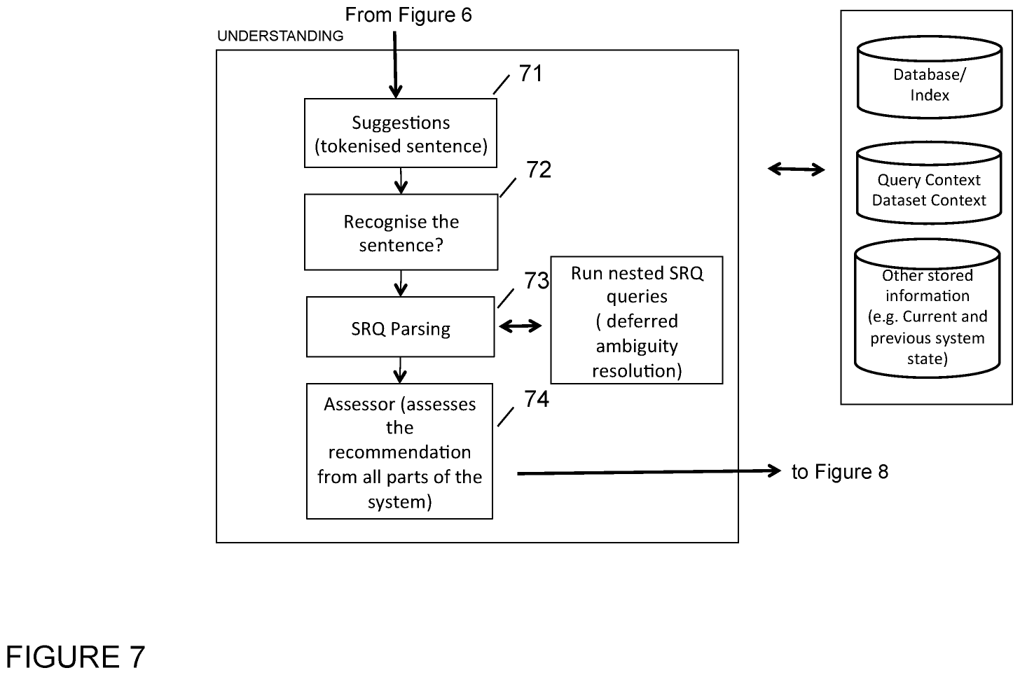

With reference to FIG. 7, the top suggestions are first tokenised (71). Based on the data from the knowledge database holding information on previous searches, the system may then recognize the sentence (72). If the tokenized suggestions are recognized in whole or in part, they are directly transformed into SRQ statements (73). The assessor (74) receives the suggested SRQ queries and assigns weighting based on a number of metrics and rules as described in previous sections.

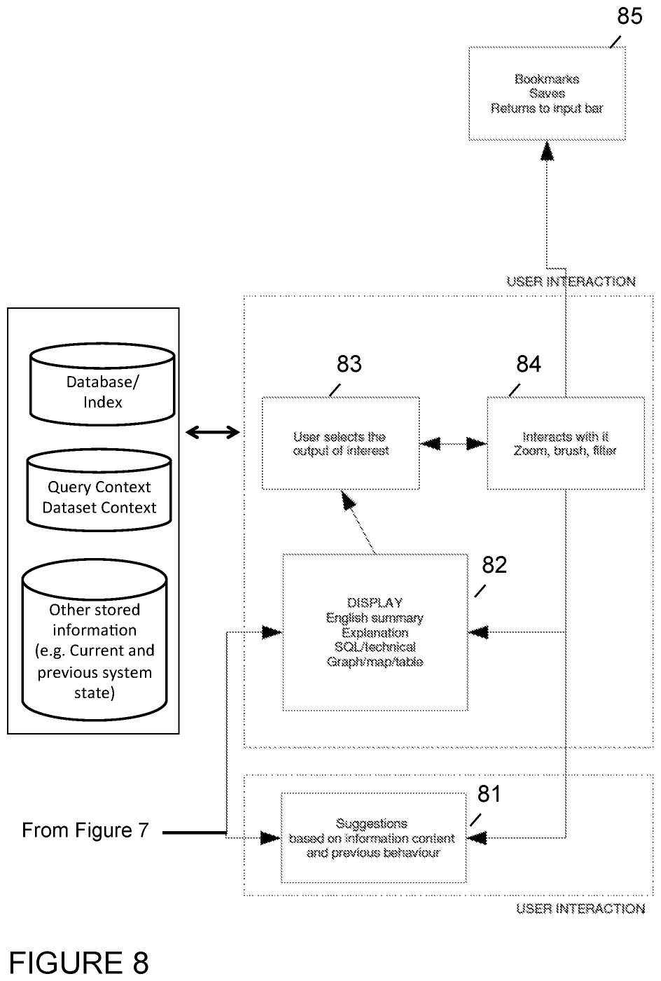

With reference to FIG. 8, for each suggested query, the interpreter finally generates a structured dataset and displays the answer to the end user (for example the average price by town in Nottinghamshire is displayed). Additional suggestions may also be selected and displayed to the end-user (82) based on further insight such as a reinforcement learning strategy (for example: the average price by town and the maximum of that are displayed). The reinforcement learning strategy may take into account information content and previous behaviour such as, but not limited to: end-user interaction (e.g. click (83), exploration of a graph such as zoom, brush, filter (84), bookmarks, saves, returns to input bar (85), frequency of use of a noun or contradictions from the end-users.

The steps presented in these diagrams have been simplified for illustration purposes and do not necessarily represent an exhaustive list of steps performed by the system.

The answers displayed to the end-user and the metrics used to ranking the answers are also continuously updated and improved with user feedback. The system may also return a stream of answers. Initially a finite number of answers may be displayed (limited by the amount of information which can be/should be displayed on the screen). These Answers may be categorised into one or more streams, which may be ordered by the probability/weight assigned to each answer.

### 2.5 Key Features of the User Experience

As the metric of success for the application is to make the exploration of data as easy as possible for as many people as possible (§ 1.1), the user interface (UI) must allow non-technical users to use the product without the need for training. This precludes the use of complex menus and contrived drag-and-drop interfaces as seen in competitor products.

Examples of user interfaces are now given.

### 2.5.1 Appearance of the Import Page

The import page allows the user to bring a source dataset into the application painlessly and see an overview of it quickly.

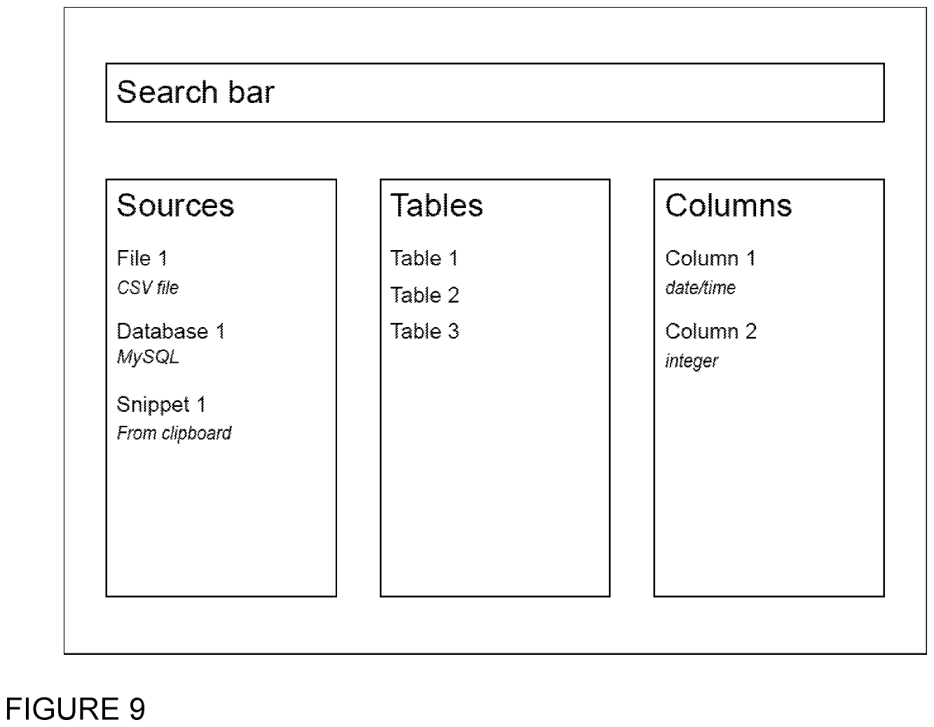

With reference to FIG. 9, along with the search bar, the import page comprises three panels: “Sources”; “Tables”; and “Columns”. The user begins by adding one or more sources, which may be (but are not limited to) files (e.g., CSV, TSV, JSON, XML), database connections (e.g., MySQL, PostgreSQL, etc.) or buffers from the clipboard. Feedback is provided on the progress of loading large sources, as well as various inferred parameters, e.g., the character set (§ 2.1.1), table structure (§ 2.1.2), etc. The user has the option of overriding these.

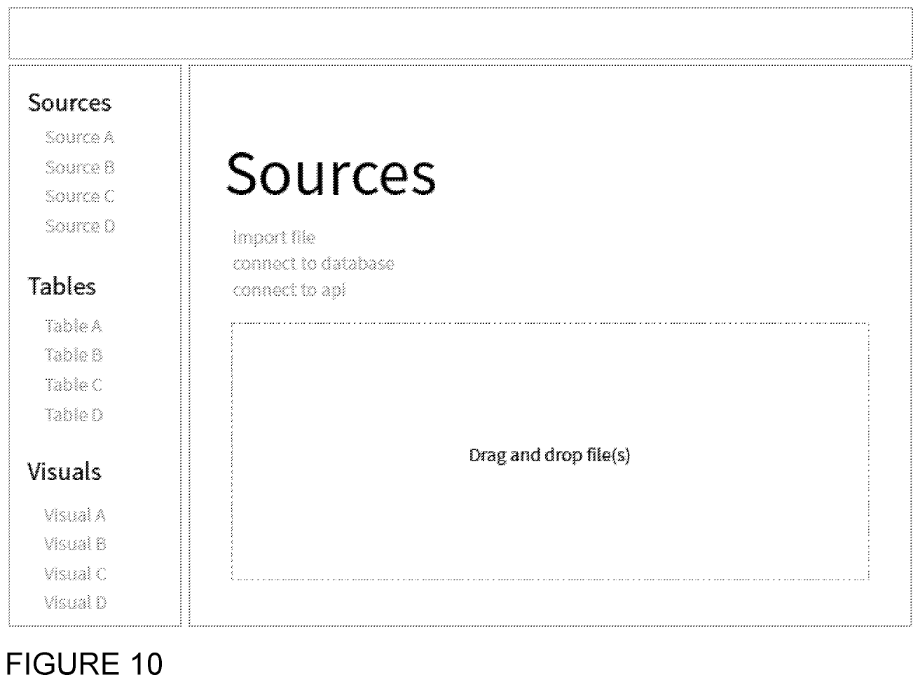

FIG. 10 shows another example of an import page, where the user is able to drag and drop one or more files containing one or more source datasets they wish to use.

Each source may contain one or more tables, which can be explored by clicking on the corresponding source. Tables can also quickly be previewed in full.

Each table may contain one or more columns, which can be seen by clicking on the corresponding table. Here the user can check and edit column names and types and quickly inspect the distribution of each column. Any errors and/or inconsistencies can then be rectified in the edit page (§ 5.2).

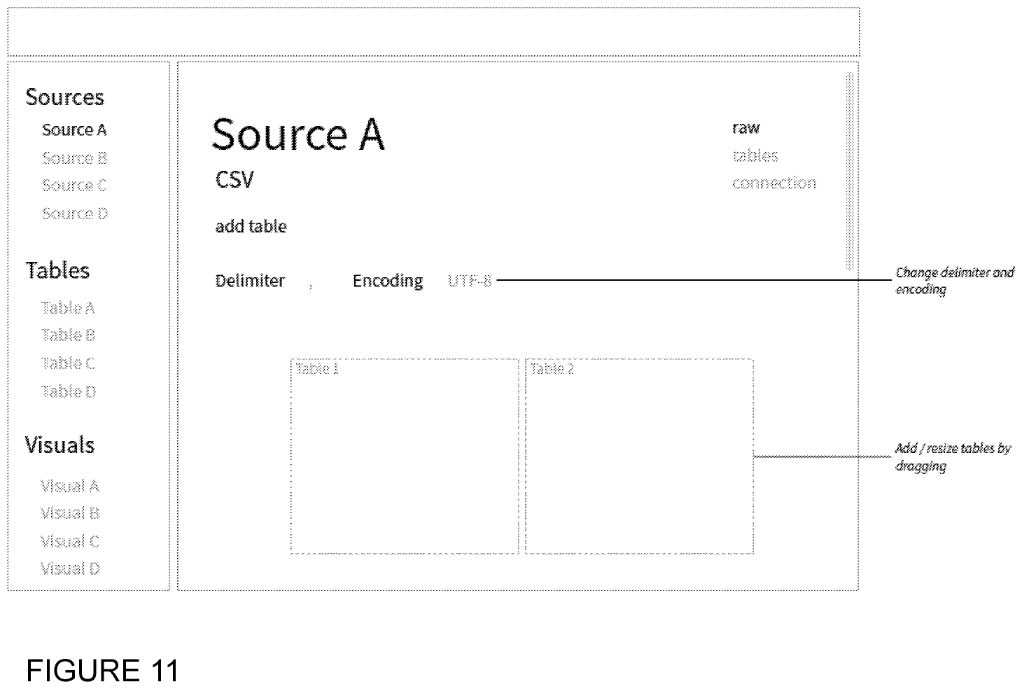

FIG. 11 shows another example of page displaying the preview of a source dataset in raw format. The end-user is able to change any delimiter and encoding, and to add or resize a table.

### 2.5.2 Appearance of the Edit Page

The edit page allows the user to manipulate data within a (single) table and apply global filters using natural language.

There are two primary views in the edit page: a table view and column view. The table view allows the user to see all rows and columns in the table quickly, and sort by any column.

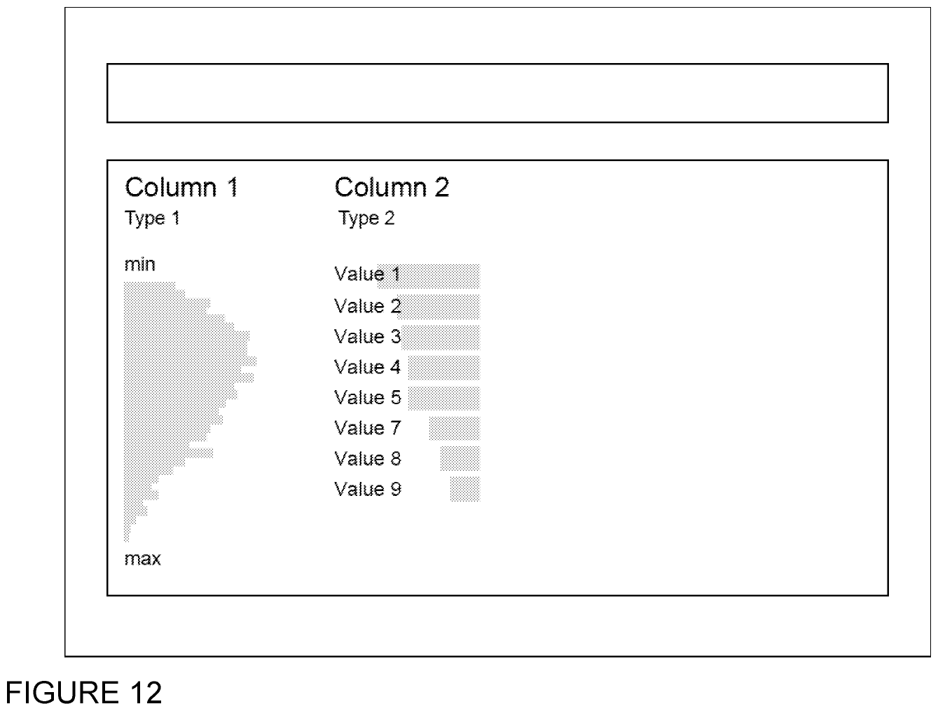

With reference to FIG. 12, a column view of the edit page is shown where a user is able to view the distribution of all columns quickly, find and replace values within columns and apply global filters (that permeate the rest of the application).

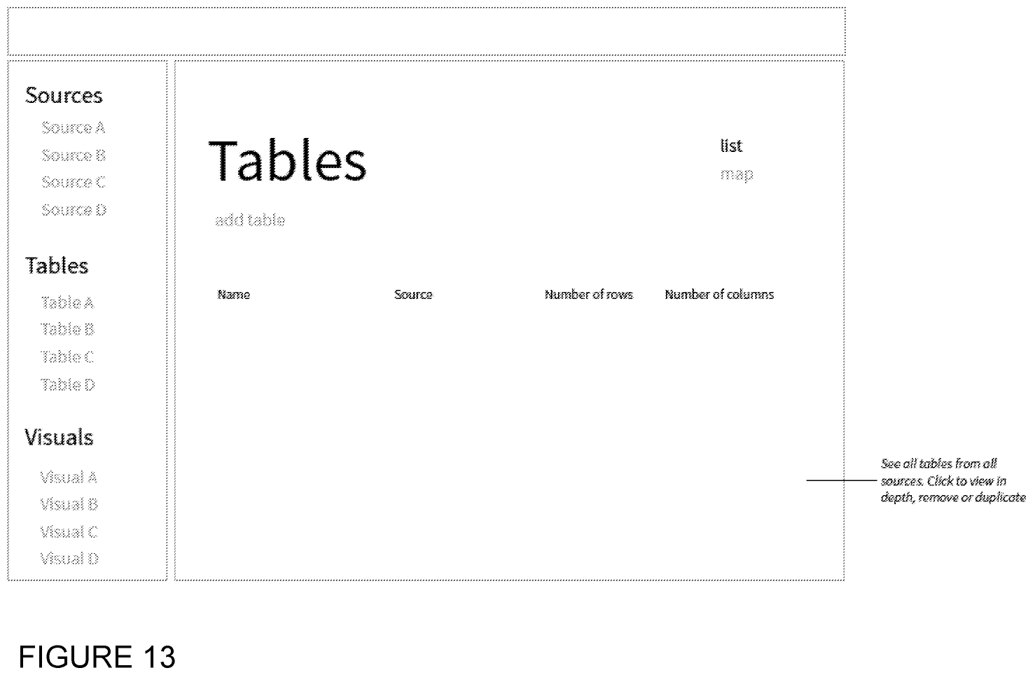

With reference to FIG. 13, a page may also display all the tables from the source dataset(s) that have been imported by the end-user. The end-user is able to click to explore a specific table in more depth. A table may also be removed or duplicated.

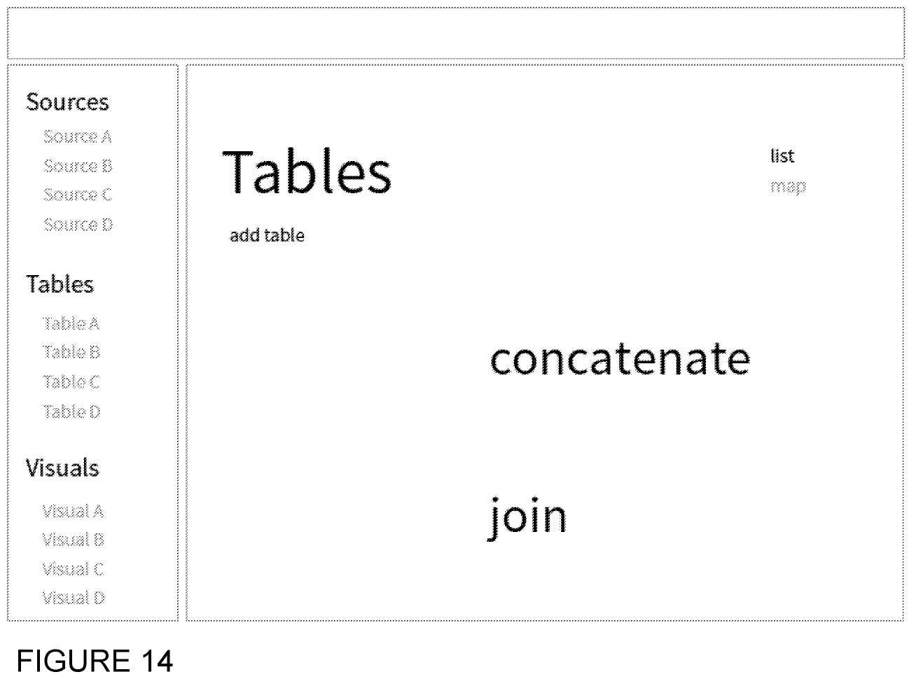

With reference to FIG. 14, a page is shown where the user is able to add a table, concatenate or join multiple tables.

### 2.5.3 Appearance of the Explore Page

The explore page allows the user to query the data using natural language, with rich visuals produced directly from NL statements. A user may select to explore one, several or all of the tables created from the imported sources (§ 5.1). For cases where more than one table is selected, the application may automatically join tables (depending on the exact query), as described in § 3.3.

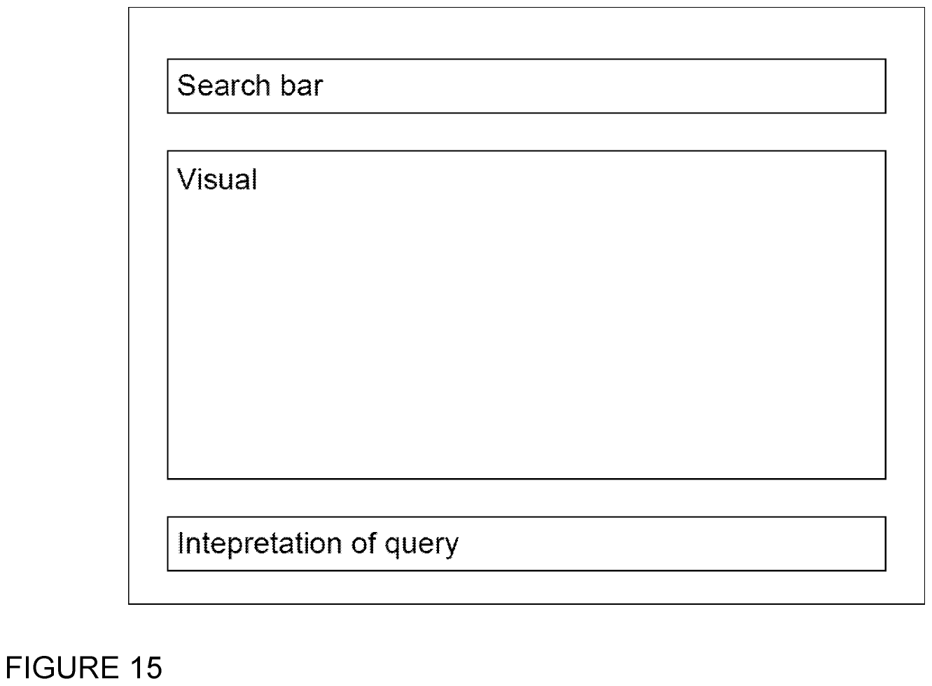

With reference to FIG. 15, the core constituents of the explore page are shown; the user types into the search bar and a visual and logical interpretation are returned.

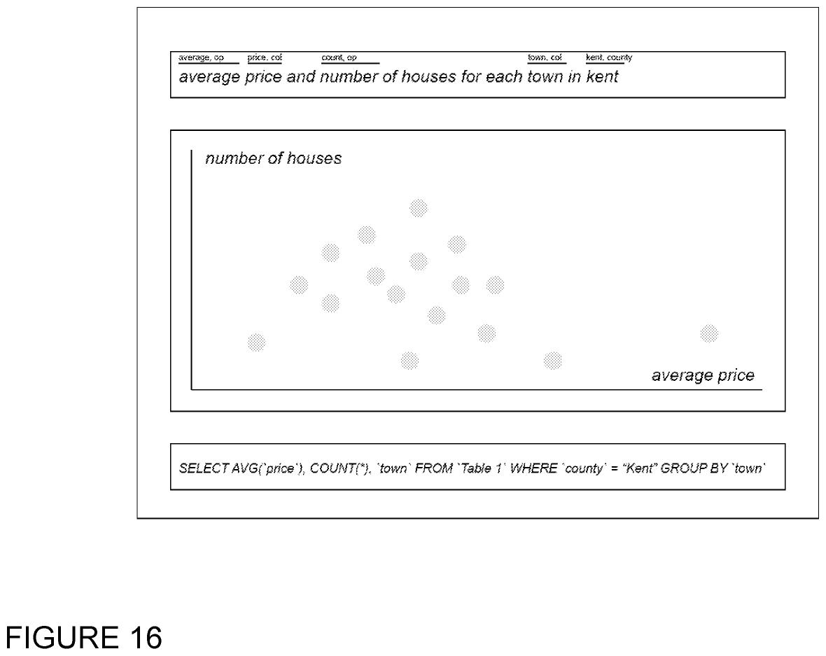

FIG. 16 shows an example of the explore page—an example natural language query, with a simple schematic of the returned visual and SQL interpretation. The named entities are highlighted here (“op” corresponds to an operator, “col” to a column and “county” is a column name).

The query processing routines detailed in § 4 underpin the search capability.

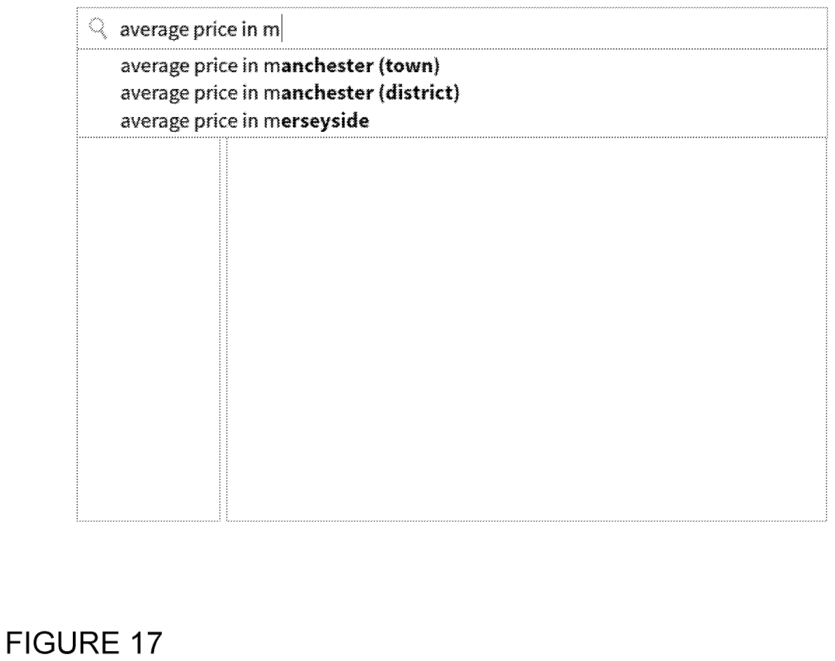

FIG. 17 illustrates an example in which as the user types, several autocomplete suggestions are returned based on the root of their query. Clicking on one of these brings up the relevant chart below. As the user types, they may receive both autocomplete suggestions for the query, (FIG. 13) and feedback on the named entities identified within the query (FIG. 12); they are then are able to adjust this accordingly as per § 4.5.

The types of visual produced may include, but are not limited to:
Bar chart
Scatter chart
Bubble chart
Line chart
Histogram
Choropleth
Point/heat map
Table

A method by which we infer the type of visual to use is detailed in § 5.5.

An interpretation allows the user to check that the computer has understood the query correctly and may take one of the following forms:
I. Natural language—designed for non-technical users. A description of the steps taken by the database is returned in NL.
II. SQL—for advanced users, designed to allow analysts to use the app to explore samples of large tables/databases quickly and then use the generated SQL query on the database directly.

Users are able to switch quickly between these options.

### 2.5.4 Automatic Provision of Visuals

Typically a user of a data analytics product either does not know the contents of the dataset or is unaware of what the most interesting features of it are. Competitor products do little to help with this, beyond providing a table view that allows the user to explore the data through simple inspection.

Making the “null query” results returned valuable may be dependent for example on learnt context from other datasets and stored ‘state’ of previous sessions. Not only is the homepage auto populated with content, the elements of the template are also selected based on the dataset itself—we are doing both content generation and template creation—it is an automated version of, for example, the BBC homepage—where a news stories is generated and presented in such a way to reflect the users' interests and the quality or relevance of answers.

While this is possible in our application, the user is also helped in exploring the data by the automatic provision of charts, both:
I. Before the user has performed any queries.
Instant suggestions are automatically extracting from the imported dataset(s) without requiring an input or action from the end-user, and are automatically displayed.
In making a simple, unnested SQL statement, the interface uses natural language to populate the SELECT and GROUP BY parts of the statement but uses click based methods to do the filtering in the WHERE or HAVING part (e.g. filtering for elements, by numerical or date range), and provide any commands to the ORDER BY part.
WHERE filters on columns can also be accessed in the natural language part, however it is intended that this should become the secondary method for the user. Particularly for the multiple-user or server solution this scales more poorly alone than if integrated with click-based methods.

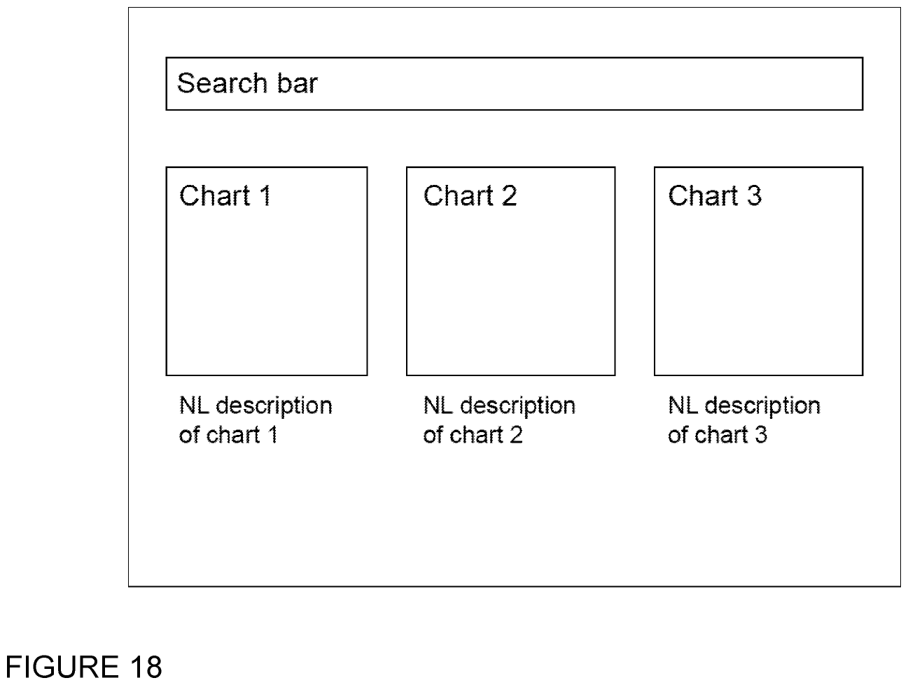

With reference to FIG. 18, an example of a page is shown displaying a number of charts automatically to an end-user. a number of charts are produced automatically, before the user has submitted any queries. These can be used as a starting point for analysis of the data.

Using a combination of rule-based and learnt behaviour, we provide:
(a) Charts similar to those produced in previous user interactions with this dataset (if any), or charts similar to those produced in previous interactions with datasets containing similar column types and/or names.
(b) Template-based charts. For example:
   i. Timeseries—if the data contains a single time column and one or more numerical columns, a timeseries is provided.
   ii. Maps—if a column(s) corresponding to statistical geographies with well-defined boundaries can be identified, a choropleth is provided. If other geographical fields can be identified (e.g., longitude/latitude, postcodes, zip-codes), a point or heat map is provided.
   iii. Distributions—the distribution of low-to-moderate (˜10) cardinality columns (in the case of categorical columns) or numerical columns are provided.
   iv. Correlations—if the data contains two highly correlated columns, either before or after some form of aggregation, a scatter plot of the two columns is provided.
II. After the user has performed one or more queries. As the user queries the data, multiple charts are suggested, which branch from the current line of enquiry. These may be determined by:
   (a) Adding further grouping to the query (in the case of aggregated queries).
   (b) Selecting different metrics but retaining the same grouping and filters of the query.
   (c) Modifying the filter of the query.

Any of these charts can be clicked on by the user and explored more fully. Each chart is presented with a succinct NL description so that it can be quickly understood by the user.

Note that this functionality overlaps and interfaces with that described in § 4.10.

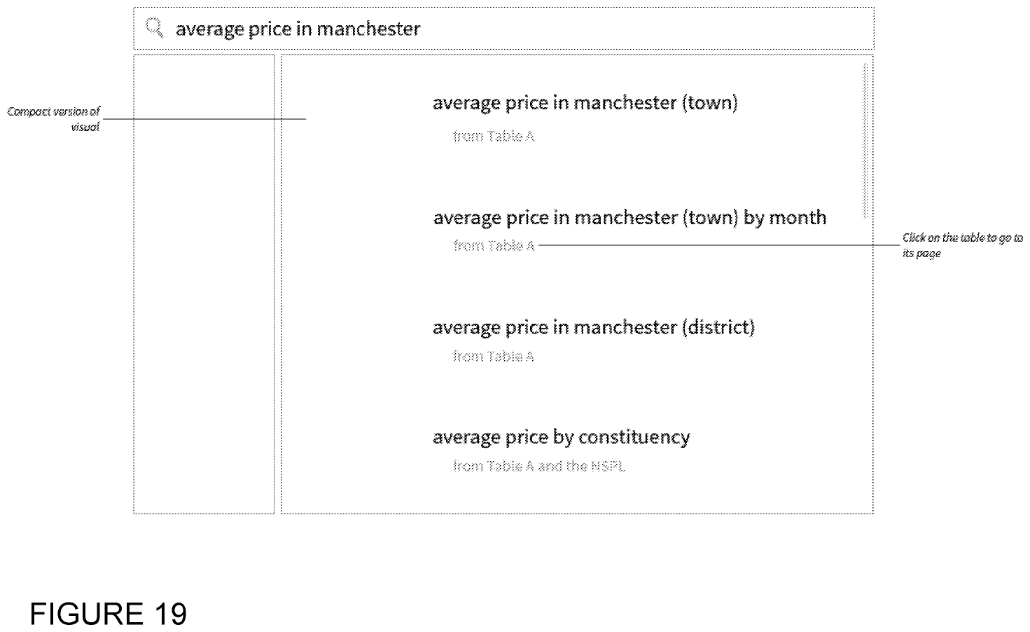

FIG. 19 shows another example of a page automatically displaying a number of charts to an end-user. In this example the end-user has selected ‘average price in manchester’ as a query. The query is processed alongside suggested queries and the system simultaneously resolves and presents the exact answer ‘average price in manchester (town)’ alongside the following suggested answers: ‘average price in manchester (town) by month’, ‘average price in manchester (district)’ and ‘average price by constituency’.

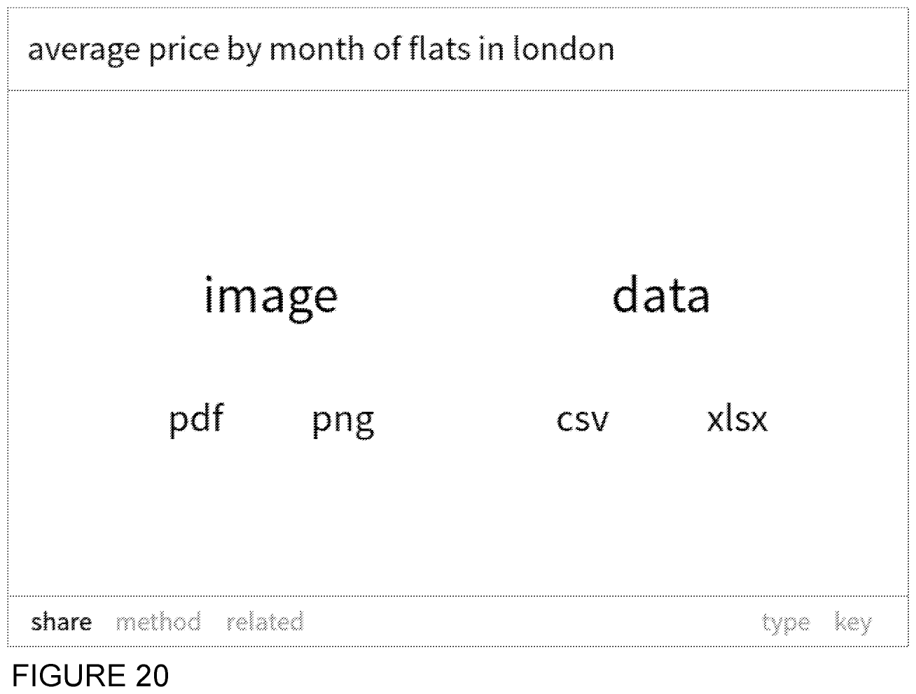

FIG. 20 shows another example of a page displaying answers to the end-user. The sentence ‘average price by month of flats in london’ is displayed on top of the page and corresponds to a description of the answers provided. A number of options are provided to the end-user at the bottom of the page, in order for the end-user to share the answers (‘share’), to display the steps used by the interpreter to process the query and the dataset (‘method’) or to see related answers (‘related’).

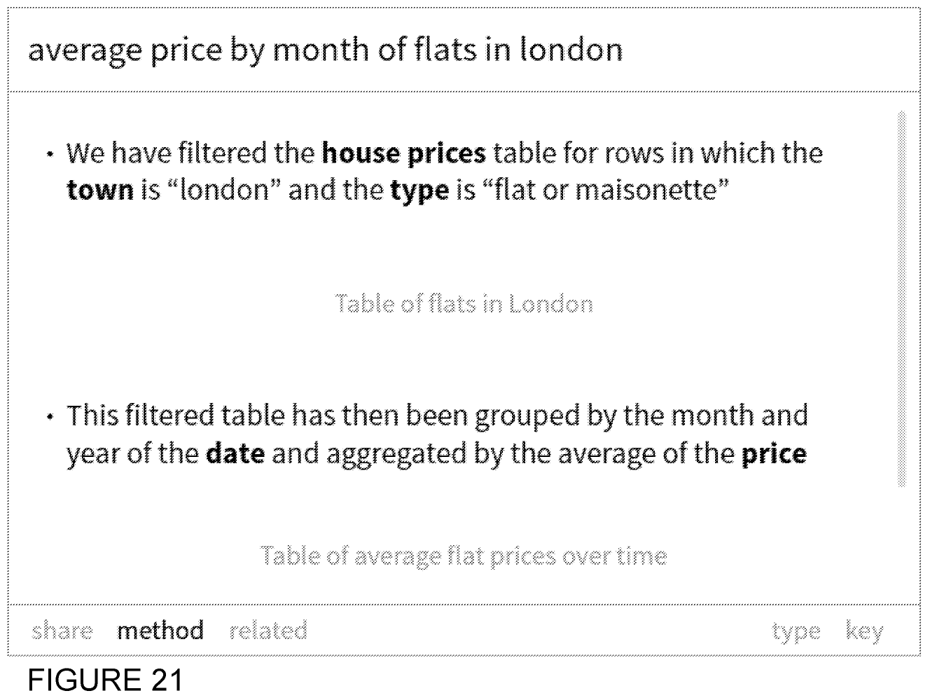

FIG. 21 shows a page corresponding to when the end-user has selected the ‘method’ option, and in which the steps or instructions used by the interpreter to process the query and the dataset are displayed to the end-user.

### 2.5.5 Automatic Inference of the Type of Visual Required

Let's say we have a table containing columns of types: i) numerical (corresponding to integer or float types); ii) categorical (category or range); iii) geography; and iv) date/time, which are inferred on import. A NL query is submitted by the user, which is parsed using the methods in § 4 and data is correspondingly returned from the database (§ 3), which itself contains columns of these four types. The way in which the data is displayed is determined as follows:
I. 1 numerical and 1 categorical column—to be displayed as a bar chart, with the categorical column determining the x position of each bar, and the numerical column determining the height h of each bar.
II. 1 numerical and 2 categorical columns—to be displayed as a bar chart, with the categorical columns determining the x position and colour c of each bar, and the numerical column determining the height h of each bar. A key mapping the colours to the second categorical column is to be displayed next to chart.
III. 1 numerical and 1 geography column—to be displayed as a choropleth, in the case that pre-defined boundaries exist for the geographical column, or as a point/heat map if no statistical boundaries exist.
IV. 1 numerical and 1 date/time column—to be displayed as a timeseries, in which the temporal column determines the x position of points and the numerical column the y position.
V. 1 numerical and 1 date/time column—to be displayed as timeseries, in which the temporal column determines the x position of points and the numerical column the y position.
VI. 2 numerical columns—to be displayed either as i) a scatter chart or ii) a line chart, dependent on whether the data is ordered by one of the columns or not.
VII. 2 numerical columns—to be displayed either as i) a scatter chart or ii) a line chart, dependent on whether the data is ordered by one of the columns or not.
VIII. 3 numerical columns—to be displayed either as i) a bubble chart or ii) a bar/line chart with dual y-axes.
IX. 3 numerical columns with 1 categorical/geography column—to be displayed as a bubble chart, with the numerical columns determining each bubble's x position,y position and radius r.
X. 4 numerical columns with 1 categorical/geography column—to be displayed as a bubble chart, with the numerical columns determining each bubble's x position, y position, radius r and colour c.
XI. 3 numerical columns with 2 categorical/geography columns—to be displayed as a bubble chart, with the numerical columns determining each bubble's x position, y position and radius r and the categorical columns determining each bubble's colour c and ID.
XII. All columns in the original table—for queries of the form SELECT * FROM <table name> . . . , to be displayed as a table, unless each column has explicitly been mentioned by the user in the NL statement.

For example, say we have a table with columns “price” (numerical), “product” (categorical), “category” (categorical) and “date” (date/time). The queries
“total sales by month” would return a timeseries as per III.
“average price per product and category” would return a bar chart as per I.
“items more expensive than $10 sold in July 2016” would return a table as per XII.

Although I-XII represent the default types of visual produced, the user may override these.

### 2.5.6 User Interface Screenshots

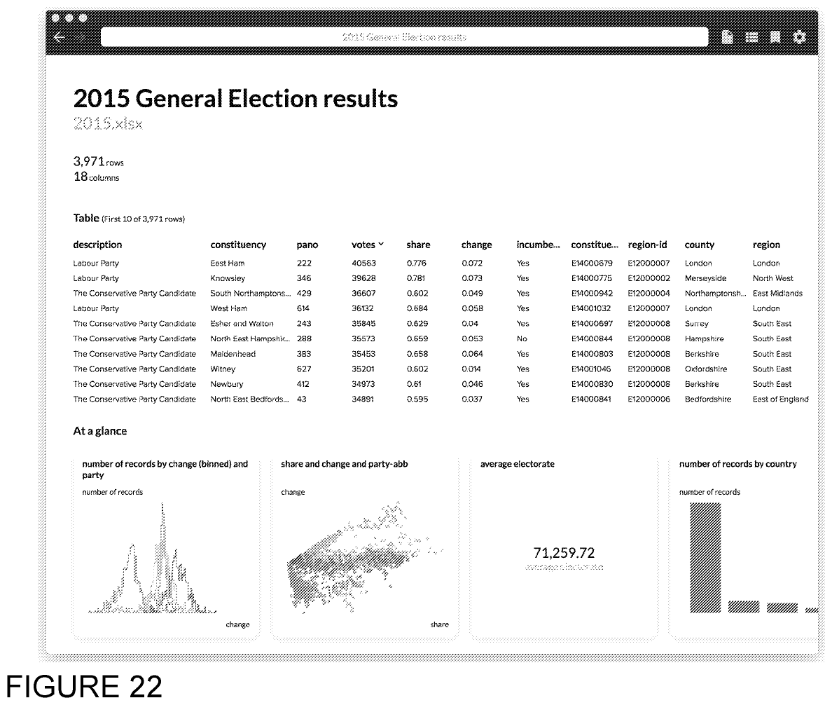

FIG. 22 shows a screenshot of a home page. In this example, the source dataset contains data from the 2015 general election results. The source dataset is automatically displayed alongside a number of suggested answers.

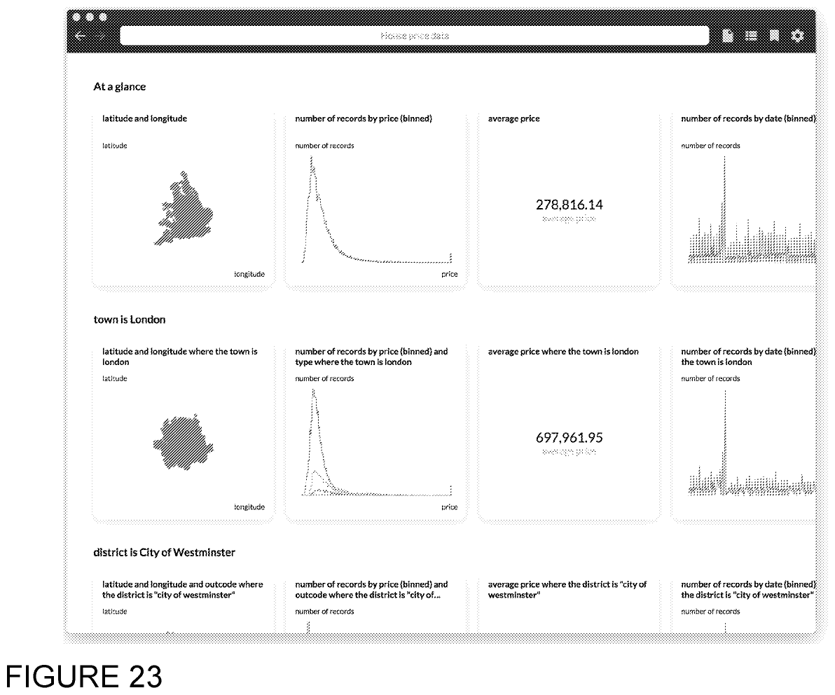

FIG. 23 shows a screenshot with an example of the user interface when the query is a ‘null query’. The null query automatically gives a stream of meaningful answers from the interpretation of the source dataset and a stored knowledge of the interpreter. In this example, the source dataset contains house price data, and the homepage displays suggested answers such as a map of latitude and longitude, a plot of the number of records by price, or a value of the average price.

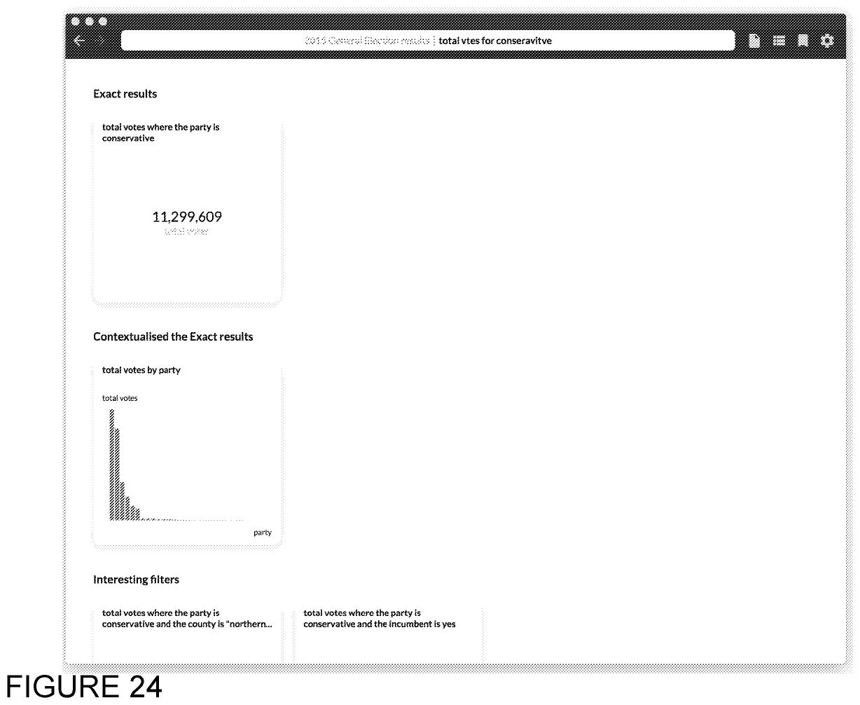

FIG. 24 shows a screenshot with an example of the user interface in response to an imprecise or incomplete query (‘total votes for conservative’) returning a selection of exact results (‘total votes where the party is conservative’, ‘total votes by party’) and suggestions such as the ‘total votes where the party is conservative and the county is northern . . . ’ and ‘total votes where the party is conservative and the incumbent is yes’.

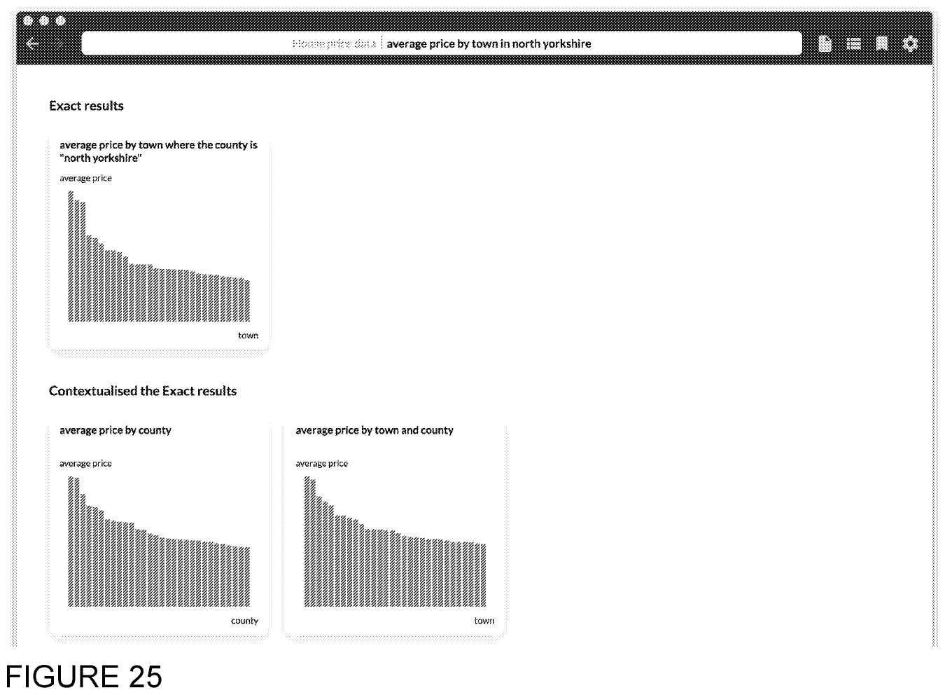

FIG. 25 shows a screenshot with an example of the user interface in response to a precise query (‘average price by town in north yorkshire’) returning the obviously exact answer (‘average price by town where the county is “north yorkshire’”).

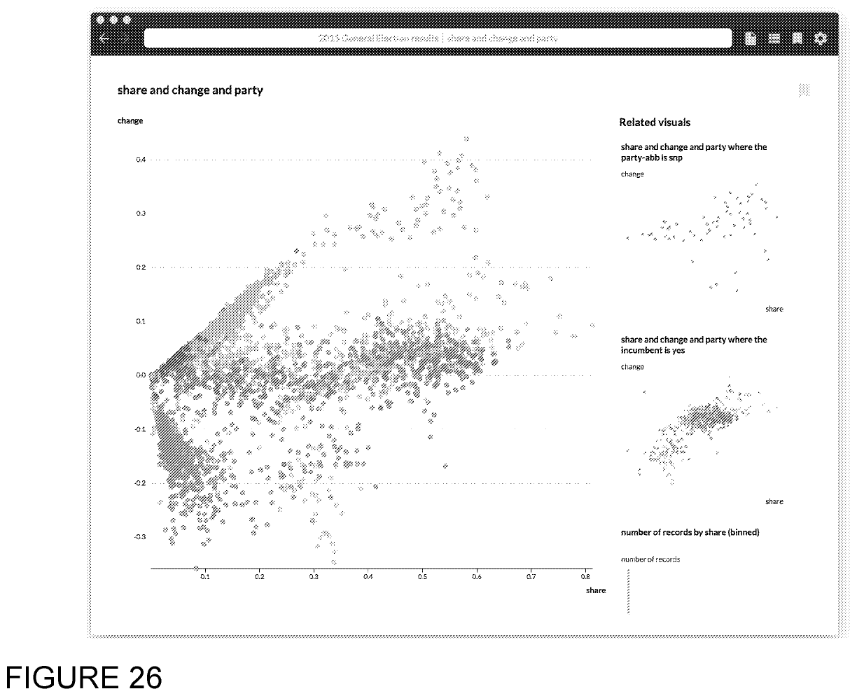

FIG. 26 shows a screenshot with an example illustrating a graph that is displayed alongside suggestions as a side column. The user may interact with the graph to display another set of answers or may scroll down the suggested stream of answers displayed on the side.

### APPENDIX A: PARSERS

### A.1 Consistent Parsing is a Key Part of the User Experience

A key aspect of the experience is consistency. If an entry in a table can be parsed for example “5 Mar. 2016” is recognised as the date 05/03/2016—it must also be parsed if encountered in another dataset or in any other interaction of the user with the product. In our code the same parsers are used throughout, enabling this experience. This is not possible if an integrated interface and database is not used.

### A.2 Date Parser

Date is a key concept, with applications in various fields. (For example, Python's dateutils library, which has a subset of the functionality of our dateparser and also does not use any of the innovations discussed below has been downloaded 40 million times: pypi-ranking.info/alltime.) The methods described below are not just an extension of existing techniques (e.g. to more periods) but the methods used for inference of ranges, repetition and financial concepts appear to be novel.

Our dateparser takes as an input either a string or a list of strings. It outputs the most likely dates represented in those strings.

In the case of a single string, we first tokenise it:
F—a financial year
Y—number (2 or 4 digits), or 1 if following another year
q—the presence of the word quarter or Q (an uncommon letter)
Q—number 1≤x≤4
M—number 1≤x≤12
m—string of length n which is the same as the first n digits of a month-name (this is particularly important for “mar”/“march”→“march”, but not e.g. “marvellous”→“march”
W—number 1≤x≤52
D—number 1≤x≤31
t—st, nd, th etc., marked if matches preceding number
H—number 1≤x≤24
T—number 1≤x≤60
S—number 1≤x≤60
V—number 1≤x≤999 (milliseconds)
a—am/pm

For example, “11 March 16”→{Y, D, H, T, S} m {Y, D, H, T, S}.

Alternatively, there could be a range of dates. There remains an ambiguity, however, in that the day and year is not recognised. We assign a probability based on:
I. Flagging—e.g. the presence of p and q
II. Pairing—e.g. 2011/12 is often a financial year not a Y/M
III. Consistency—if m is used, M is not (and vice versa).
IV. Contiguity—a date needs to contain a continuous group of at least one of each of the following classes:
V. Continuity—A higher weighting is assigned if the classes are next to each other as in the list, i.e. there is some ordering to them. This fails slightly for DMY HTS or the common mDY but is generally robust against ‘silly’ parses e.g. the HmD i.e. 11 o'clock on the 16th of March is given a low weighting.
VI. Ranges
   (a) If there is a range, this must include the element furthest down the class list, and the elements which are ranged must be contiguous e.g. “12-15 Feb. 2016” cannot be hours, “11 3-4 2016” would be weighted towards November, not March-April, and “12 Feb. to 15 Mar. 2016” makes sense.
   (b) An exception is 2016-17, financial years, these are coalesced into a separate, F object, and the same rules applied.
   (c) If a range appears to be identified, the formatting is examined to look for consistency in the position and separators of the elements—“24/3-26/4-2016” makes sense, however “24:3/26 4-2016” is confusing even to a human. Also “24/3-4/26 2016” is disallowed.
   (d) The range should be weighted more highly if it increases in time left to right. Decreasing ranges are rare, and certainly should not be assumed.
VII. Normalisation—The epoch e.g. ˜2000 can be applied such that 49→2049. The locale, predominantly DMY vs MDY can be specified, this can also be locally stored—e.g. if inferred from a dataset. Other languages can be easily implemented in the month names, e.g. “Apr”→“Avr”. Significant support for, for example, Japanese dynastic years, are already provided in C++ 11 libraries and by the CLDR (cldr.unicode.org) and these can be incorporated.

### APPENDIX B: KEY FEATURES

This section summarises the most important high-level features (A->T); an implementation of the invention may include one or more of these high-level features, or any combination of any of these. Note that each high-level feature is therefore potentially a stand-alone invention and may be combined with any one or more other high-level feature or features or any of the ‘optional’ features; the actual invention defined in this particular specification is however defined by the appended claims.

### A. The Simultaneous, Linked Analysis of a Dataset and a Query

A computer-implemented method of querying a source dataset, in which:

(i) a user provides a query to a dataset querying system; and
(ii) the system automatically processes simultaneously and/or in a linked manner both the dataset and the query, so that processing the query influences the processing of the dataset, and/or processing the dataset influences the processing of the query.
B. Answering the User's Intent, Rather than the Precise Query Asked

A computer-implemented method of querying a source dataset, in which:

(i) a user provides a query to a dataset querying system; and
(ii) the system automatically processes the query and the dataset to derive a probabilistic inference of the intent behind the query.
C. Iterative Process where Every Inferred Intent Generates Multiple Possible Answers Based Around that Intent

A computer-implemented method of querying a source dataset, in which:

(i) a user provides a query to a dataset querying system; and
(ii) the system automatically processes the query and the dataset and dynamically generates a series of relevance-ranked attempts to answer that query or to infer the intent behind the query as an initial processing step; and
(iii) the user further expresses their intent by interacting with the relevance-ranked attempts to answer that query (e.g. enters a modified query, selects a part of a graph) and the system then iteratively improves or varies how it initially processed the query and the dataset, as opposed to processing in a manner unrelated to the initial processing step, to dynamically generate and display further relevance-ranked attempts to answer that query, to enable the user to iteratively explore the dataset or reach a useful answer.

### D. The Interpreter

A computer-implemented method of querying a source dataset, in which a user provides a query to a dataset querying system, and the query is processed by an interpreter that derives a probabilistic inference of intent, or interpretation, of the query.

Optional features in an implementation of the invention include any one or more of the following:
The interpreter learns from previous user inputs or interactions.
The interpreter automatically generates and displays a set of multiple candidate answers, and a user's interaction with the set of candidate answers enables the interpreter to improve its inference of the intent behind that query.
The interpreter (i) cleans the source dataset to generate a cleaned, structured dataset and (ii) translates the query to form a structured query.
The interpreter ranks graphs for display ordering using metrics that are a function of the data distribution properties of each graph.
The interpreter generates and displays multiple answers (e.g. different graphs) to the query, and processes a user's selection of a specific answer to trigger the further querying of the dataset, or a modified representation of that dataset, and for further answers to consequently be displayed, so that the user can iteratively explore the dataset.
The interpreter generates and displays multiple answers (e.g. different graphs) to the query, and if the user zooms into or otherwise selects a specific part of an answer, such as a specific part of a graph or other visual output, then the interpreter uses that selection to refine its understanding of the intent behind the query and automatically triggers a fresh query of the dataset, or a modified representation of that dataset, and then generates and displays a refined answer, in the form of further or modified graphs or other visual outputs, so that the user can iteratively explore the dataset.
The interpreter infers or predicts properties of the likely result of the query before actually using the dataset, or a database derived from the dataset
The interpreter uses properties of the query, the dataset, previous queries, previous datasets, currently visible datasets.
the interpreter learns and infers intent from previous user inputs or interactions.
The interpreter also infers intent using rules based behaviour.
The interpreter uses the dataset context and the query context to generate autocomplete suggestions that are displayed to an end-user, and in which selection of a suggestion is then used by the interpreter to modify the dataset context and the query context or to select a different dataset context and query context and to use the modified or different dataset context and query context when generating an answer.
The interpreter infers the type or types of answers to be presented that are most likely to be useful to the user or best satisfy their intent, e.g. whether to display charts, maps or other info-graphics, tables or AR or VR information, or any other sort of information.
Only a single interpreter performs the actions defined above.
The interpreter is a computer implemented interpreter.

### E. The Dataset Context

A computer-implemented method of querying a source dataset, in which an interpreter creates, uses or stores a ‘dataset context’ when it cleans the source dataset to generate the cleaned, structured dataset, the dataset context being the information applied to the source dataset or extracted from it, when the source dataset is cleaned.

Optional features in an implementation of the invention may include the following:
The interpreter creates, uses or stores a ‘dataset context’ or an estimate of a dataset context when it estimates how to process the source dataset to generate a cleaned, structured dataset, the dataset context being the information it anticipates applying to the source dataset or extracting from it, when the source dataset is cleaned.
The interpreter simultaneously creates the dataset context and the query context when it analyses the query.
The interpreter simultaneously creates, when it analyses the query: (i) a structured dataset by cleaning the source dataset; (ii) a structured query by translating the query and (iii) a dataset context and a query context, which may be treated computationally substantially as one entity.
The interpreter displays the data context and query context to a user in order to permit the user to edit or refine the contexts and hence resolve any ambiguities.
The interpreter displays the entirety of the dataset context and query context, and any antecedent dataset context and a query context, to the end-user in an editable form to enable the end-user to see how the structured dataset was generated and to edit or modify the dataset context and/or the query context.

### F. The Query Context

A computer-implemented method of querying a source dataset, in which a user provides a query to a dataset querying system and in which an interpreter creates, uses or stores a ‘query context’ when it analyses the query, the query context being the information applied to the query or extracted from it, when the query is translated to generate a structured query.

Optional features in an implementation of the invention include any one or more of the following:
The interpreter creates, uses or stores a ‘query context’ or an estimate of a query context when it estimates how to process the query to generate a structured query, the query context being the information it anticipates it will apply to the query or extract from it, when the query is translated to generate a structured query.
The interpreter simultaneously creates the dataset context and the query context when it analyses the query.
The interpreter simultaneously creates, when it analyses the query: (i) a structured dataset by cleaning the source dataset; (ii) a structured query by translating the query and (iii) a dataset context and a query context, which may be treated computationally substantially as one entity.
The interpreter displays the data context and query context to a user in order to permit the user to edit or refine the contexts and hence resolve any ambiguities.
The interpreter displays the entirety of the dataset context and query context, and any antecedent dataset context and a query context, to the end-user in an editable form to enable the end-user to see how the structured dataset was generated and to edit or modify the dataset context and/or the query context.

### G. Joining Across Multiple Source Datasets

A computer-implemented method of querying a source dataset, in which a user provides a query to a dataset querying system and in which a query (i) triggers joining across multiple source datasets and (ii) the dynamic creation of a different database or dataset using data from the joined source datasets, that different database or dataset being analysed to generate one or more answers to the query.

Optional features in an implementation of the invention include any one or more of the following:
The interpreter joins across multiple source datasets in response to a query or a user instruction to analyse multiple source datasets.
The interpreter joins across multiple datasets without the need of a query or a user interaction, in which zero, one or more of the datasets are from a stored corpus of knowledge such as a user generated library.
The interpreter joins any pair within the multiple datasets either directly or via a route through one or more other datasets (‘route-finding’)
The interpreter estimates the validity or the result of joining the one or more datasets, using a rule based approach and/or learnt information before joining the one or more datasets.
The interpreter joins across multiple source datasets in response to a query and creates a cleaned, structured dataset using data from the joined source datasets.

### H. Probabilistic Interpreter

A computer-implemented method of querying a source dataset, in which a user provides a query to a dataset querying system, and the query is processed by an interpreter that derives a probabilistic inference of intent, or interpretation, of the query, and in which the interpreter generates a series of probability ranked structured datasets.

Optional features in an implementation of the invention include any one or more of the following:
The interpreter operates probabilistically to estimate a series of probability ranked structured datasets.
The interpreter operates probabilistically to estimate a series of probability ranked answers, in the process of probabilistically estimating the properties of multiple structured datasets and queries.
The interpreter generates and displays a set of multiple candidate answers, organized into one or more streams, and each stream includes an arbitrarily large number of answers, the interpreter operating probabilistically to generate a series of probability ranked answers, in the process of creating multiple structured datasets and queries.
The interpreter assesses the degree of inaccuracy or imprecision of a query and returns answers to the user with a breadth that is a function of this degree of inaccuracy or imprecision.
The interpreter operates probabilistically to generate a series of ranked sets of {structured dataset, structured query, context, answer}, each set being assigned a probability.
The interpreter operates probabilistically to generate or estimate a sample or sub-sample of a series of ranked sets of {structured dataset, structured query, context, answer}, each set, or the process needed to generate such a set, being assigned an estimated probability.
The interpreter operates probabilistically to either estimate or explicitly generate the instructions needed in order to make a series of ranked sets of {structured dataset, structured query, context, answer}, each set, or the instructions to generate such a set, being assigned a probability.

The interpreter, when it receives a query, generates a series of a ranked set of {structured dataset, structured query, context, answer}, each set being assigned a probability and each set being specific to a computer-generated inference of the intent behind that query.
The interpreter generates probability rankings using information that is specific or local to the query or source dataset and also using information that is part of a stored corpus of knowledge that is not specific or local to the query or source dataset.
The interpreter generates probability rankings using information that is specific or local to the query or source dataset and also using information that is part of a stored corpus of knowledge that is not specific or local to the query or source dataset, and weights or gives priority to the information that is specific or local to the query.
The interpreter, when it receives a query, generates a series of a ranked set of {structured dataset, structured query, context, answer}, each set being assigned a probability, so that it will always generate at least one answer to the query.
The interpreter, when it receives a null query, generates a series of a ranked set of {structured dataset, structured query, context, answer}, each set being assigned a probability, using information that is part of a stored corpus of knowledge stored or accessed by the interpreter.
The interpreter stores some or all of the sets of {structured dataset, structured query, context, answer}, to enable subsequent analysis or verification or re-use.
the interpreter stores some or all of the sets of {structured dataset, structured query, context, answer}, to enable further datasets to be joined to the source dataset to enable the breadth or accuracy of answers to later queries, to be enhanced.
The interpreter stores some or all of the sets of {structured dataset, structured query, context, answer} to improve the estimates generated by the interpreter.
the interpreter automatically permutes the query (e.g. by adding aggregators) and then ranks predicted answers according to a metric that define likely usefulness or interest to the user.

### I. Dynamic Manipulation of the Dataset in Response to a Query

A computer-implemented method of querying a source dataset, in which a user provides a query to a dataset querying system and an interpreter dynamically manipulates the dataset in response to the query.

Optional features in an implementation of the invention include any one or more of the following:
The interpreter cleans the dataset in response to the query to generate a cleaned, structured dataset
The interpreter cleans the dataset in response to the query in a manner or extent that is a function of the content of the query.
The interpreter translates the query into a structured query at substantially the same time as it cleans the dataset.

### J. Inferring Properties of the Result

A computer-implemented method of querying a source dataset, in which a user provides a query to a dataset querying system, and the query is processed by an interpreter that infers or predicts properties of the result of the query before using the dataset or a database derived from the dataset.

Optional features in an implementation of the invention include any one or more of the following
The interpreter, using only a sample or sub-sample of the dataset, infers or predicts a set of dataset contexts and query contexts; then estimates a set of answers based on the inferred or predicted contexts; and then ranks the set of answers.
The interpreter, using only metadata on the dataset, infers or predicts a set of dataset contexts and query contexts; then estimates a set of answers based on the inferred or predicted contexts; and then ranks the set of answers.
The interpreter, using a quantity of information which is substantially smaller than the information contained in the set of answers it is estimating the properties of, infers or predicts a set of dataset contexts and query contexts; then estimates a set of answers based on the inferred or predicted contexts; and then ranks the set of answers.
The interpreter, using a quantity of information derived from the dataset which is independent of, or has a substantially sub-linear scaling in, the size of the possible set of answers it is estimating the properties of, infers or predicts a set of dataset contexts and query contexts; then estimates a set of answers based on the inferred or predicted contexts; and then ranks the set of answers.
The interpreter processes a query to: predict a set of dataset contexts and query contexts, estimate a set of answers based on the predicted contexts and rank each estimated answer according to a metric.
The interpreter processes a query to: predict a set of dataset contexts and query contexts estimate a set of answers (or structured queries) based on the predicted contexts rank each estimated answer according to a metric, and generate a ‘best guess’ answer or a set of ‘top n’ answers based on the ranking of the estimated answers.
Predicted answers are ranked according to a metric, and the metric is a function of one or more of the following: the predicted number of results, the type of query, the arrangement of words or tokens in the query, the number of results relative to the number of rows inputted, the distribution of a numerical column, the spread of a numerical column, the cardinality of a word column, the number of unique elements with frequency of occurrence over a given fraction of the cardinality of a word column, whether a column contains outliers and what they are, the spread of the binned average between multiple columns, the properties of one column against another column, the correlation between multiple columns, click based information from the end-user, previous actions of an average user, proximity to the inferred intent of the user, properties of a sub-sampled result of the query, the end-user parameters such as role or expertise level, the number of datasets used, the proportion of records or the absolute number used to join two or more datasets.

### K. An Answer is Always Given

A computer-implemented method of querying a source dataset, in which a user provides a query to a dataset querying system and any query, precise or imprecise, always results in an answer being presented to the user, even if it is a very low probability answer.

L. Multiple Answers Enable a User to Try More Meaningful Queries A computer-implemented method of querying a source dataset, in which a user provides a query to a dataset querying system and in which the query results in a number or a range of answers being presented to the user, enabling the user to understand the data or metadata in the source dataset, or the content or structure of the source dataset, and to hence try a more meaningful query.

### M. 1 Step Browse and Search

A computer-implemented method of querying a source dataset, in which a user provides a query to a dataset querying system and in which the degree of inaccuracy or imprecision of the query is assessed and the breadth of the search results or answers that are returned to the user is a function of this degree of inaccuracy or imprecision.

An optional feature in an implementation of the invention includes the following.
The method combines search with browse in a single query step.

### N. Auto-Populated Home Page

A computer-implemented method of querying a source dataset, in which a user provides a query to a dataset querying system and in which an interpreter automatically generates and displays a home or summary page from the dataset in response to a null query, and that home or summary page includes multiple charts or graphics or other information types.

Optional features in an implementation of the invention include any one or more of the following:
The method enables a user to explore the source dataset in an intuitive manner.
The automatic generation of answers is based on generating preliminary answers, such as charts, and ranking these preliminary answers for properties that will make them interesting to a user, such as a broad pattern or distribution of results, clustering of results, inherent or common associations between parameters, variation in results, previous interest by the user in similar columns, entities, aggregators.
The user can scroll through the home or summary page and new charts or graphs are automatically revealed.
The dataset or database can be processed using a drag and drop action to start that processing.

### O. The Database

Computer implemented method for use in a database in which a database holds data from the source dataset, and the database is automatically structured to handle imprecise data queries and imprecise datasets.

Optional features in an implementation of the invention include any one or more of the following:
The database ingests and stores data from the source dataset as contiguous streams, in memory, as a column-based database.
The database stores a raw copy of the dataset so that no information is ever lost.
The database generates an index, allowing fast access to individual records or groups of records in the dataset.
The database generates an index, allowing fast access to individual records or groups of records in the dataset, in which indexes of each column of the dataset are stored using a reduced form string.
As much information as possible has been removed from the reduced form string while keeping it computationally recognisable (‘fuzzy indexing’).
Transliteration or phonetic transcription is used to render the string in a reduced character set.
Transliteration and/or or phonetic transcription is used to render the string in the subset of ASCII which does not contain uppercase letters.
The indexes reside in memory.
The database enables lookups to be of constant or substantially sub-linear time.
The lookups can be approximate or exact by default (fuzzy indexing enables fuzzy joining).
When using a fuzzy index, the database pulls out a small number of candidate variables (which can then also be displayed to the user for ‘autocomplete’ or disambiguation) and then checks for equality rather than looks for the exact variable straight away.
The database includes a fast (constant or substantially sub-linear time) look-up of a value both in a dictionary of the values in a column and the row positions in a column of those values.
The dictionary of the fuzzy index on a column allows one or more of the following: fuzzified grouping by the column or an acceleration of linear-time general spell checking, or an acceleration of linear, sub-linear or constant time spell checking restricted to certain operations such as operations in the ‘Norvig spellchecker’.
The index on the columns enables an acceleration of finding an individual string split across multiple columns.
The database groups data according to common features.
The database includes the ability to join datasets, where joining is based on performing a fuzzy match between two columns or a group of columns.
The database caches full queries without any limiting of the number of entries returned from the table to allow a fluid browsing of results displayed to the user.
The database runs and stores an interim table for each step of a query execution to allow audit, playback by the user and easy re-running based on edits.
The database probabilistically infers a suitable encoding or structure for the dataset being ingested, which can be viewed and/or overridden by the user.
The index system enables the exploration of a dataset in one language using a keyboard in a different language.
The index system also enables the compression of the data in string columns using the dictionary, since the integers derived from enumerating the dictionary are necessarily smaller than the strings they enumerate. This scheme of compression also increases the speed of grouping on the columns, which is not true of a general compression scheme.

### P. Understanding the Query Based on its Relationship to the Dataset

A computer-implemented method of querying a source dataset, in which a user provides a query to a dataset querying system and in which the query is tokenized and the entities in the query are each assigned a weighting based on the entity relationship with the dataset.
A SRQ parser that uses only non-Part of Speech tokens to create a possible SRQ statement is used.
A SRQ parser based on a probabilistic rule-based approach and learnt behaviour is used.

### Q. A Flexible Date Parser

Computer implemented method for processing a string, or list of strings, in which a date parser takes as an input a string, or list of strings, converts it to the most likely date or dates represented in those strings and outputs a date information.

Optional features in an implementation of the invention include any one or more of the following:
The date information is in a standardised time format.
The method further outputs a chance that the date information is correct, in which the chance is assigned probabilistically.
The date information includes a date, a year, a month.
The method further recognises that each element of a the string or list of strings, as one of a number of possible tokens (such as date, year, month) according to rules on the ranges and/or format of each possible token.
The presence or not of one or more tokens is required based on the presence of not of one or more other tokens, taking into account the proximity of the different tokens.
The method further enforces the continuity of the tokens in the string or list of strings, the probability that the date information is correct being higher if the temporal duration of a token is close to that of a surrounding token or to the range of temporal durations seen in a surrounding group of tokens. For example, before a month, day and year an hour might be expected, but not a minute “5 pm on Mar. 15, 2017” not “25 minutes past on Mar. 15, 2017”.
The method further enforces that, if there is a range expressed in the string or list of strings, it must include the token/s of shortest temporal duration. If a financial year is expressed, the years are coalesced into a single temporal duration and the same rule is enforced. For example 20^{th} to 25^{th} of March would be a range expressed in a string.
The method further enforces that, if there is a range expressed, the separators (/, :, etc.) are consistent between the same temporal durations when they recur.
The method enforces a normalisation to a spatial and temporal locale. For example (UK, circa 2000) (03/05/15 is 3 May 2015), or {US, circa 1900} (03/05/15 is 5 Mar. 1915).
The time information also includes a location information or time information.

### R. The Integrated System

A computer-implemented data query system that includes an interpreter or probabilistic interpreter as defined above; a database as defined above; and a user interface to accept queries and display answers, such as charts, maps or other information, operating as an integrated system, where the system automatically processes (e.g. cleans) the dataset and processes (e.g. translates) the query simultaneously or in a linked manner, so that processing the query influences the processing of the dataset, and/or processing the dataset influences the processing of the query.

Optional features in an implementation of the invention include any one or more of the following.
The system uses the same entity parsers for processing the dataset and for processing the query, allowing consistency throughout the system.
The system implements any of the methods defined above.

### S. Recording, Storing and Sharing the State of the System

A computer-implemented data query system that includes an interpreter or probabilistic interpreter as defined above; a database as defined above; and a user interface to accept queries and display answers, such as charts, maps or other information, operating as an integrated system, where the system automatically processes (e.g. cleans) the dataset and processes (e.g. translates) the query simultaneously or in a linked manner, so that processing the query influences the processing of the dataset, and/or processing the dataset influences the processing of the query, in which the properties of the system can be recorded and stored, and in which the properties of the system (or ‘state’) can include any combination of one or more of the following: query, structured query, raw dataset, cleaned dataset, interpreter, dataset context, query context, answer or user behaviour.

Optional features in an implementation of the invention include any one or more of the following
The state of a previous session can be uploaded into the system.
The properties of a local interpreter are updated using the whole or partial state of a previous session.
A local state is recorded after anonymising any one or more of the properties of the system.
A previously recorded state can be uploaded such that it synchronises with a local interpreter for the duration of a session.
Multiple sessions separated by other unrelated sessions can hold a state (both through saving state and through recognition by the interpreter of the interrelatedness of the sessions) over time as if unseparated by the unrelated sessions.

### T. Use Cases

The method or system is used as part of a web search process and the imprecise raw datasets are WWW web pages.

The method or system is used as part of a web search process and the imprecise raw datasets are the entirety of indexed WWW web pages.

The method or system is used as an IOT query or analysis system, and the imprecise raw datasets are the data generated by multiple IOT devices.

The method or system is used as an IOT query or analysis system, and the imprecise raw datasets are the data generated by multiple IOT devices using different metadata or labelling structures that attribute meaning to the data generated by the IOT devices.

The method or system is used as part of a web search process that serves answers and relevant advertising to an end-user in response to a query

The method or system is used to query property related data and the system joins the datasets from multiple sources, such as government land registry, estate agents, schools, restaurants, mapping, demographic, or any other source with data of interest to a house purchaser or renter

The method or system is used to query flights or travel data and the system joins the flight timetables and prices from various airlines and OTAs

The method or system is used to query entertainment data. The method of any preceding claim, when used to query restaurant data

The method or system is used to query hotel data.

The method or system is used to query financial data.

The method or system is used to query personal financial data.

The method or system is used to query sensitive personal data.

The method or system is used to query retail data.

The method or system is used to query customer data.

The method or system is used to query manufacturing data.

The method or system is used to query property data.

The method or system is used to query company accounts.

The method or system is used to query sensitive health data.

The method or system is used to query any business, operational, personal, geographical data, or any other kind of data.

The method or system is used to create a valuation for a dataset.

U. Key Dependent Claims that are Common Across Multiple High Level Features

Optional features in an implementation of the invention may include any one or more of the following:
A text entered as a text string into a search bar, or as speech captured by a speech recognition and analysis engine, or as a construction using tokenized building blocks produced from scratch, from click-based interactions, from interactions with other elements in the system such as charts or axes.
A query is processed to generate an exact query as well as a series of suggested queries and the exact query and suggested queries are simultaneously resolved and presented, to provide an exact answer alongside suggested answers.
Answers from the query are presented as charts, maps or other info-graphics.
Answers from the query are presented as tables or AR (Augmented Reality) information or VR(Virtual Reality) information.
The method or system automatically infers the type or types of answers to be presented that are most likely to be useful to the user or best satisfy their intent, such as whether to display charts, maps or other info-graphics, tables or AR or VR information, or any other sort of information.
The query is an imprecise NL (Natural Language) query.
The NL query is used as a direct input to the database, such that there is no gateway to the database demanding precision.
NL is used not with the aim of understanding the meaning of the query, but to translate the query into a plausible database query.
The query includes keywords/tokens representing click based filters or other non-text inputted entities mixed in.
A user or interpreter generated global filter is applied to a column of the dataset, or the database.
The database generates a query match or ‘best guess’ that is a probabilistic maximum, or a number of ‘best guesses’ which form the ‘top n’, from a set of probabilistic maxima that each are a function of the individual components of the query and/or the interactions between the individual components of the query.
The method or system enables joining across or sending queries to any number of imprecise datasets since we do not require matching datasets but can probabilistically model matches across different datasets.
A synonym matching process is used when processing the dataset and the query that is inherently fuzzy or imprecise or probabilistically modelled.
The method or system presents the user with representations of his query that start with the system's ‘best guess’ and then iteratively resolve ambiguities with further user input until an output is generated or displayed such as a visualisation that is a precise as the dataset allows.
The method or system allows anyone to write complex queries across a large number of curated or uncurated datasets. The inherently ambiguous or imperfect queries are processed and fed as data queries to a database that is structured to handle imprecise data queries and imprecise datasets.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer-implemented method of querying a source dataset, in which:
(i) a user provides a query to a dataset querying system; and
(ii) the system automatically processes simultaneously and/or in a linked manner both the dataset and the query, so that processing the query influences the processing of the dataset, and/or processing the dataset influences the processing of the query.

2. A computer-implemented method of querying a source dataset, in which:
(i) a user provides a query to a dataset querying system; and
(ii) the system automatically processes the query and the dataset to derive a probabilistic inference of the intent behind the query.

3. A computer-implemented method of querying a source dataset, in which:
(i) a user provides a query to a dataset querying system; and
(ii) the system automatically processes the query and the dataset and dynamically generates a series of relevance-ranked attempts to answer that query or to infer the intent behind the query as an initial processing step; and
(iii) the user further expresses their intent by interacting with the relevance-ranked attempts to answer that query (e.g. enters a modified query, selects a part of a graph) and the system then iteratively improves or varies how it initially processed the query and the dataset, as opposed to processing in a manner unrelated to the initial processing step, to dynamically generate and display further relevance-ranked attempts to answer that query, to enable the user to iteratively explore the dataset or reach a useful answer.

4. The method of claim 1, in which the query is processed by an interpreter.

5-12. (canceled)

13. The method of claim 3, in which an interpreter simultaneously creates a dataset context, the dataset context being the information the interpreter anticipates it will apply to the source dataset or extract from it, when the source is cleaned and a query context when it analyses the query, the query context being the information the interpreter anticipates it will apply to the query or extract from it, when the query is translated to generate a structured.

14. (canceled)

15. The method of claim 13, in which the interpreter displays the data context and query context to a user in order to permit the user to edit or refine the contexts and hence resolve any ambiguities.

16. The method of claim 13, in which the interpreter displays the entirety of the dataset context and query context, and any antecedent dataset context and a query context, to the end-user in an editable form to enable the end-user to see how the structured dataset was generated and to edit or modify the dataset context and/or the query context.

17. (canceled)

18. The method of claim 4, in which an interpreter generates and displays multiple answers (e.g. different graphs) to the query, and processes a user's selection of a specific answer to trigger the further querying of the dataset, or a modified representation of that dataset, and for further answers to consequently be displayed, so that the user can iteratively explore the dataset.

19. The method of claim 4, in which an interpreter generates and displays multiple answers (e.g. different graphs) to the query, and if the user zooms into or otherwise selects a specific part of an answer, such as a specific part of a graph or other visual output, then the interpreter uses that selection to refine its understanding of the intent behind the query and automatically triggers a fresh query of the dataset, or a modified representation of that dataset, and then generates and displays a refined answer, in the form of further or modified graphs or other visual outputs, so that the user can iteratively explore the dataset.

20. The method of claim 4, in which an interpreter infers or predicts properties of the likely result of the query before actually using the dataset, or a database derived from the dataset.

21-28. (canceled)

29. The method of claim 13, in which the interpreter uses the dataset context and the query context to generate autocomplete suggestions that are displayed to an end-user, and in which selection of a suggestion is then used by the interpreter to modify the dataset context and the query context or to select a different dataset context and query context and to use the modified or different dataset context and query context when generating an answer.

30. The method of claim 4, in which the interpreter infers the type or types of answers to be presented that are most likely to be useful to the user or best satisfy their intent, e.g. whether to display charts, maps or other info-graphics, tables or AR or VR information, or any other sort of information.

31. The method of claim 4, in which only a single interpreter performs the actions defined above.

32-36. (canceled)

37. The method of claim 4, in which the interpreter operates probabilistically to generate a series of ranked sets of {structured dataset, structured query, context, answer}, each set being assigned a probability.

38. The method of claim 4, in which the interpreter operates probabilistically to generate or estimate a sample or sub-sample of a series of ranked sets of {structured dataset, structured query, context, answer}, each set, or the process needed to generate such a set, being assigned an estimated probability.

39. The method of claim 4, in which the interpreter operates probabilistically to estimate or generate instructions needed in order to make a series of ranked sets of {structured dataset, structured query, context, answer}, each set, or the instructions to generate such a set, being assigned a probability.

40-48. (canceled)

49. The method of claim 4, in which the interpreter dynamically manipulates the dataset in response to the query.

50-52. (canceled)

53. The method of claim 4, in which the interpreter infers or predicts properties of the result of the query before using the dataset or a column-based database derived from the dataset.

54. The method of claim 4, in which the interpreter, using only a sample or sub-sample of the dataset, infers or predicts a set of dataset contexts and query contexts; then estimates a set of answers based on the inferred or predicted contexts; and then ranks the set of answers.

55. The method of claim 4, in which the interpreter, using only metadata on the dataset, infers or predicts a set of dataset contexts and query contexts; then estimates a set of answers based on the inferred or predicted contexts; and then ranks the set of answers.

56. The method of claim 4, using a quantity of information which is substantially smaller than the information contained in a set of answers it is estimating the properties of, infers or predicts a set of dataset contexts and query contexts; then estimates a set of answers based on the inferred or predicted contexts; and then ranks the set of answers.

57. The method of claim 4, in which the interpreter, using a quantity of information derived from the dataset which is independent of, or has a substantially sub-linear scaling in, the size of the possible set of answers it is estimating the properties of, infers or predicts a set of dataset contexts and query contexts; then estimates a set of answers based on the inferred or predicted contexts; and then ranks the set of answers.

58-63. (canceled)

64. The method of claim 1, in which a database holds data from the source dataset, and the database is automatically structured to handle imprecise data queries and imprecise datasets, and the database generates an index, allowing fast access to individual records or groups of records in the dataset, in which indexes of each column of the dataset are stored using a reduced form string.

65. The method of claim 64, in which as much information as possible has been removed from the reduced form string while keeping it computationally recognisable (‘fuzzy indexing’).

66-70. (canceled)

71. The method of claim 1 in which a database holds data from the source dataset, and the database is automatically structured to handle imprecise data queries and imprecise datasets; and which the database includes a fast (constant or substantially sub-linear time) look-up of a value both in a dictionary of a values in a column and the row positions in a column of those values, and in which the dictionary of the fuzzy index on a column allows one or more of the following: fuzzified grouping by the column or an acceleration of linear-time general spell checking, or an acceleration of linear, sub-linear or constant time spell checking restricted to certain operations such as operations in the ‘Norvig spellchecker’.

72-78. (canceled)

79. The method of claim 64, in which the index system enables the exploration of a foreign language dataset in one language using a keyboard in another language.

80-82. (canceled)

83. The method of claim 1, in which a date parser is used to process the query and/or to process the dataset, and in which the date parser takes as an input a string, or list of strings, converts it to the most likely date or dates represented in those strings and outputs a date information.

84. The method of claim 83 in which the date information is in a standardised time format.

85. The method of claim 83 in which the method further outputs a chance that the date information is correct, in which the chance is assigned probabilistically.

86. The method of claim 83 in which the date information includes one or more of the following: a date, a year, a month.

87. The method of claim 83 in which the method further recognises that each element of a the string or list of strings, as one of a number of possible tokens (such as date, year, month) according to rules on the ranges and/or format of each possible token.

88. The method of claim 83 in which the presence or not of one or more tokens is required based on the presence of not of one or more other tokens, taking into account the proximity of the different tokens.

89. The method of claim 83 in which the method further enforces the continuity of the tokens in the string or list of strings, the probability that the date information is correct being higher if the temporal duration of a token is close to that of a surrounding token or to the range of temporal durations seen in a surrounding group of tokens.

90. The method of claim 83 in which the method further enforces that, if there is a range expressed in the string or list of strings, it must include the token/s of shortest temporal duration.

91. The method of claim 83 in which the method further enforces that, if there is a range expressed, the separators (such as/or:) are consistent between the same temporal durations when they recur.

92-96. (canceled)

97. The method of claim 1 in which answers from the query are presented as tables or AR (Augmented Reality) information or VR (Virtual Reality) information.

98-101. (canceled)

102. The method of claim 1 in which the query includes keywords/tokens representing click based filters or other non-text inputted entities mixed in.

103. The method of claim 1 where a user or interpreter generated global filter is applied to a column of the dataset, or the database.

104-108. (canceled)

109. The method of claim 1, when used as part of a web search process and the imprecise raw datasets are WWW web pages.

110-111. (canceled)

112. The method of any claim 1, when used as an IOT query or analysis system, and the imprecise raw datasets are the data generated by multiple IOT devices using different metadata or labelling structures that attribute meaning to the data generated by the IOT devices.

113. The method of claim 1, when used as part of a web search process that serves answers and relevant advertising to an end-user in response to a query.

114-120. (canceled)

121. The method of claim 1, when used to create a valuation for a dataset.

122-123. (canceled)

124. A computer-implemented system for querying a source dataset, in which a user provides a query to the dataset querying system; and
(i) the system is configured to automatically process the query and the dataset and dynamically generate a series of relevance-ranked attempts to answer that query or to infer the intent behind the query as an initial processing step; and
(ii) the user further expresses their intent by interacting with the relevance-ranked attempts to answer that query (e.g. enters a modified query, selects a part of a graph) and the system is then configured to iteratively improve or vary how it initially processed the query and the dataset, as opposed to processing in a manner unrelated to the initial processing step, to dynamically generate and display further relevance-ranked attempts to answer that query, to enable the user to iteratively explore the dataset or reach a useful answer.

125. (canceled)

126. The computer-implemented data query system of claim 124 that uses the same entity parsers for processing the dataset and for processing the query, allowing consistency throughout the system.

127-132. (canceled)
